(19) United States
(12) Patent Application Publication
(10) Pub. No.: US 2012/0246060 A1
(43) Pub. Date: Sep. 27, 2012

(54) LOAN MANAGEMENT, REAL-TIME MONITORING, ANALYTICS, AND DATA REFRESH SYSTEM AND METHOD

(75) Inventors: Howard H. Conyack, JR., Hackettstown, NJ (US); Allen Pollack, Flanders, NJ (US)

(73) Assignee: LoanHD, Inc., Mount Arlington, NJ (US)

(21) Appl. No.: 13/426,827

(22) Filed: Mar. 22, 2012

Related U.S. Application Data
(60) Provisional application No. 61/467,747, filed on Mar. 25, 2011.

(51) Int. Cl. G06Q 40/02

(52) U.S. Cl. 705/38

(57) ABSTRACT

A loan management, real-time monitoring, analytics, and data refresh method includes importing user loan data, validating the imported loan data, and loading the validated loan data into a loan queue under control of the user; selecting loans in the loan queue and placing the selected loans into a loan pool under control of the user; automatically without control of the user extracting loan data from the loan data for the loans in the loan pool, submitting the extracted loan data to a loan-data vendor, receiving vendor loan data generated by the loan data vendor from the extracted loan data, and integrating the vendor loan data with the loan data for the loans in the loan pool; and generating reports and alerts from the integrated loan data for the loans in the loan pool under control of the user.

### CROSS-REFERENCE TO RELATED APPLICATIONS

This application claims the benefit of U.S. Provisional Application No. 61/467,747 filed on Mar. 25, 2011, the contents of which are incorporated herein by reference in their entirety. U.S. Provisional Application No. 61/467,747 includes a specification, a claim, an abstract, FIGS. 1-7, and Appendices A and B to the specification.

### BACKGROUND

1. Field

This disclosure relates to loan management and analytics, and more particularly to a loan management, real-time monitoring, analytics, and data refresh system and method.

2. Description of Related Art

A “mortgage” is a security interest in real property held by a lender as a security for a debt, usually a loan of money. A mortgage loan is a loan secured by real property through the use of such a mortgage security interest. However, in common usage and as used herein, the term “mortgage” alone refers to a “mortgage loan.”

Mortgage lending is the primary mechanism used in the United States and many countries to finance private ownership of residential and commercial property. Mortgages are generally structured as long-term loans, with periodic payments similar to an annuity. One common arrangement requires a fixed monthly payment over a period of ten to thirty years.

Mortgage lenders provide funds against property to earn interest income, and generally borrow these funds themselves (for example, by taking deposits or issuing bonds). Typical mortgage lenders include banks, credit unions, savings and loans, and other financial institutions. In many cases, lenders may, in the United States and other countries, sell the mortgage to other parties who are interested in receiving the stream of cash payments from the borrower. However, some lenders own a portfolio of loans that they originated or purchased.

Such portfolio lenders may buy, sell, and/or trade mortgages into and out of their portfolios to, for example, manage risk and/or return in the portfolio. Consequently, portfolio lenders typically have an interest in evaluating past performance and predicting future performance of loans in their portfolio.

Many vendors collect and publish a variety of metrics that may have a bearing on the performance of an individual mortgage and/or a portfolio or mortgages. For example, a borrower's overall credit score may be at least somewhat predictive of the borrower's ability to repay the mortgage. In addition, some vendors provide mortgage-specific analytics using proprietary models to evaluate and predict borrower behavior over the lifetime of a mortgage.

However, no single model can accurately predict borrower behavior and/or loan performance 100% of the time. Additionally, many vendors may provide portfolio lenders with “raw” data, leaving it to the portfolio lender to format, present, and/or analyze the meaning of the data.

### SUMMARY

According to an aspect, a loan management, real-time monitoring, analytics, and data refresh system includes a loan data importing and validating engine configured to import user loan data, validate the imported loan data, and load the validated loan data into a loan queue under control of the user; a loan/pool managing and analyzing engine configured to select loans in the loan queue, place the selected loans into a loan pool, and analyze selected loans in the loan pool under control of the user; a vendor data integrating engine and auto-scheduler configured to automatically operate without control of the user to extract loan data from the loan data for the loans in the loan pool, submit the extracted loan data to a loan-data vendor, receive vendor loan data generated by the loan data vendor from the extracted loan data, and integrate the vendor loan data with the loan data for the loans in the loan pool; and a reporting and alerting engine configured to generate reports and alerts from the integrated loan data for the loans in the loan pool under control of the user.

The loan data importing and validating engine may be further configured to automatically correct errors in address data in the user loan data as part of the data validating.

The loan data importing and validating engine may be further configured to determine whether any data elements are missing or invalid in the user loan data; determine, for any data element that is missing or invalid, whether the missing or invalid data element is a fatal error that will prevent the vendor loan data from being obtained from the loan-data vendor, or a warning indicating that the data element is necessary to obtain the vendor loan data from the loan-data vendor but is not a fatal error; or missing address information, or an analytic error indicating that the data element is necessary to display certain charts, graphs, data tables, data analyses, trends, or other analytics in one or more reports; and generate a data quality report identifying any fatal error, any warning, any missing address information, and any analytic error.

The loan data importing and validating engine may be further configured to import the user loan data in any format desired by the user, and load the validated loan data into the loan queue in a system format required by the system.

The loan data importing and validating engine may be further configured to convert the user loan data in the user format to the system format using a data mapping template selected or created under control of the user.

The loan data importing and validating engine may be further configured to create the data mapping template by displaying a list of data elements in the user loan data in the loan queue with a drop-down box by each data element listing data elements of the system format to enable the user to map the data elements in the user loan data to the data elements of the system format by selecting a data element of the system format for each of the data elements in the user loan data using the drop-down boxes; and save the mappings as the data mapping template.

The loan/pool managing and analyzing engine may be further configured to selectively display pre-defined pool-level reports for one or more selected loan pools and pre-defined loan-level reports for loans in one or more selected loan pools under control of the user.

The pre-defined pool-level reports may include reports including selected user loan data; selected vendor loan data; at least one graphical indicator displaying the selected vendor loan data; at least one graphical indicator indicating a trend in the selected vendor loan data; at least one historical graph showing the trend in the selected vendor loan data; and an alert section displaying any alert that may have been triggered for any of the selected user loan data and the selected vendor loan data.

The reports may include a Risk Card including a plurality of loan data elements; and a risk gauge for each loan data element, the risk gauge including a low risk section representing a low risk range of the loan data element; a moderate risk section representing a moderate risk range of the loan data element; and a high risk section representing a high risk range of the loan data element; wherein the low risk section for the loan data element is highlighted in a first color if a value of the loan data element is in the low risk range; the moderate risk section for the loan data element is highlighted in a second color different from the first color if the value of the loan data element is in the moderate risk range; and the high risk section for the loan data element is highlighted in a third color different from the first color and the second color if the value of the loan data element is in the high risk range.

The vendor data integrating engine and auto-scheduler may be further configured to submit the extracted loan data to a plurality of loan-data vendors according to a stacking order that depends on the loan data required by each of the loan-data vendors.

The reporting and alerting engine may be further configured to create a search to search the loans in the loan pool using one or more data elements of the integrated loan data under control of the user, and display results of the search.

The reporting and alerting engine may be further configured to display the results of the search by displaying a loan pool summary of results of the search; refine the search by adding one or more data elements to the search, or deleting one or more data elements from the search, or changing search values one or more data elements of the search, or any combination thereof, under control of the user; and recalculate and display the loan pool summary each time the search is refined.

The reporting and alerting engine may be further configured to provide at least one pre-defined alert to automatically alert the user of a change in a data element of the vendor loan data when activated by the user.

The reporting and alerting engine may be further configured to e-mail to one or more recipients designated by the user a notification that the pre-defined alert has been triggered by the change in the data element of the vendor loan data.

The reporting and alerting engine may be further configured to enable the user to create at least one custom alert to automatically alert the user of a change in any data element of the vendor loan data when activated by the user.

The reporting and alerting engine may be further configured to e-mail to one or more recipients designated by the user a notification that the custom alert has been triggered by the change in the data element of the vendor loan data.

The reporting and alerting engine may be further configured to selectively display pre-defined and/or custom on-demand pool-level reports for one or more selected loan pools and pre-defined loan-level reports for loans in one or more selected loan pools under control of the user.

The pre-defined and/or custom on-demand pool-level reports may include reports including selected user loan data; selected vendor loan data; at least one graphical indicator displaying the selected vendor loan data; at least one graphical indicator indicating a trend in the selected vendor loan data; and at least one historical graph showing the trend in the selected vendor loan data.

According to an aspect, a loan management, real-time monitoring, analytics, and data refresh method includes importing user loan data, validating the imported loan data, and loading the validated loan data into a loan queue under control of the user; selecting loans in the loan queue and placing the selected loans into a loan pool under control of the user; automatically without control of the user extracting loan data from the loan data for the loans in the loan pool, submitting the extracted loan data to a loan-data vendor, receiving vendor loan data generated by the loan data vendor from the extracted loan data, and integrating the vendor loan data with the loan data for the loans in the loan pool; and generating reports and alerts from the integrated loan data for the loans in the loan pool under control of the user.

The reports may include a Risk Card including a plurality of loan data elements; and a risk gauge for each loan data element, the risk gauge including a low risk section representing a low risk range of the loan data element; a moderate risk section representing a moderate risk range of the loan data element; and a high risk section representing a high risk range of the loan data element; wherein the low risk section for the loan data element is highlighted in a first color if a value of the loan data element is in the low risk range; the moderate risk section for the loan data element is highlighted in a second color different from the first color if the value of the loan data element is in the moderate risk range; and the high risk section for the loan data element is highlighted in a third color different from the first color and the second color if the value of the loan data element is in the high risk range.

The method may further include creating a search to search the loans in the loan pool using any one or more data element of the integrated loan data under control of the user; displaying a loan pool summary of results of the search; refining the search by adding one or more data elements to the search, or deleting one or more data elements from the search, or changing search values one or more data elements of the search, or any combination thereof, under control of the user; and recalculating and redisplaying the loan pool summary each time the search is refined.

Additional aspects and/or advantages will be set forth in the description that follows, and, in part, will be obvious from the description, or may be learned by practice of the embodiments.

### BRIEF DESCRIPTION OF THE DRAWINGS

The above and/or other aspects will become apparent and more readily appreciated from the following description of embodiments, taken in conjunction with the accompanying drawings of which:

FIG. 1 illustrates an example of a network in accordance with one embodiment.

FIG. 2 illustrates an example of a meta-modeling server in accordance with one embodiment.

FIG. 3 illustrates an example of a loan portfolio meta-modeling routine in accordance with one embodiment.

FIG. 4 illustrates an example of a subroutine for obtaining a loan metric snapshot for a portfolio of loans at a particular point in time in accordance with one embodiment.

FIG. 5 illustrates an example of a subroutine for preparing a plurality of loan meta-model reports for a portfolio of loans in accordance with one embodiment.

FIG. 6 illustrates an example of a subroutine for preparing a plurality of multi-vendor loan-level reports for a portfolio of loans in accordance with one embodiment.

FIG. 7 illustrates an example of a generalized layout of a multi-vendor meta-model report for a given category and sub-category in accordance with one embodiment.

FIG. 8 illustrates an example of a LoanHD system in accordance with one embodiment.

FIG. 9 illustrates an example of a loan data importing and validating routine.

FIG. 10 illustrates an example of a loan data import subroutine in FIG. 9.

FIG. 11 illustrates an example of an address correction subroutine in FIG. 9.

FIG. 12 illustrates an example of a data quality report subroutine in FIG. 9.

FIG. 13 illustrates an example of a loan assignment subroutine in FIG. 9.

FIG. 14 illustrates an example of a loan/pool managing and analyzing routine.

FIG. 15 illustrates an example of a portion of a Risk Card in accordance with one embodiment.

FIGS. 16A and 16B illustrate an example of a vendor data integrating and auto-scheduling routine.

FIG. 17 illustrates an example of a predetermined stacking order.

FIG. 18 illustrates an example of a reporting and alerting routine.

### DESCRIPTION

Reference will now be made in detail to the embodiments, examples of which are illustrated in the accompanying drawings, wherein like reference numerals refer to like elements throughout.

In various embodiments, as described below, a loan “meta-modeling” service may collect, at multiple points in time, loan “snapshots” for each of a portfolio of loans, the snapshots being provided by multiple providers, each of which has one or more of its own specific loan “models.” Based on these snapshots, the loan meta-modeling service may provide to a portfolio holder several reports that categorize and summarize multi-vendor metrics at the portfolio level (over time from the origin of the loan to current). The loan meta-modeling service may further provide reports that categorize and aggregate multi-vendor metrics at the loan level.

The detailed description that follows is represented largely in terms of processes and symbolic representations of operations by conventional computer components, including a processor, memory storage devices for the processor, connected display devices, and input devices. Furthermore, these processes and operations may utilize conventional computer components in a heterogeneous distributed computing environment, including remote file Servers, computer Servers, and memory storage devices. Each of these conventional distributed computing components is accessible by the processor via a communication network.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

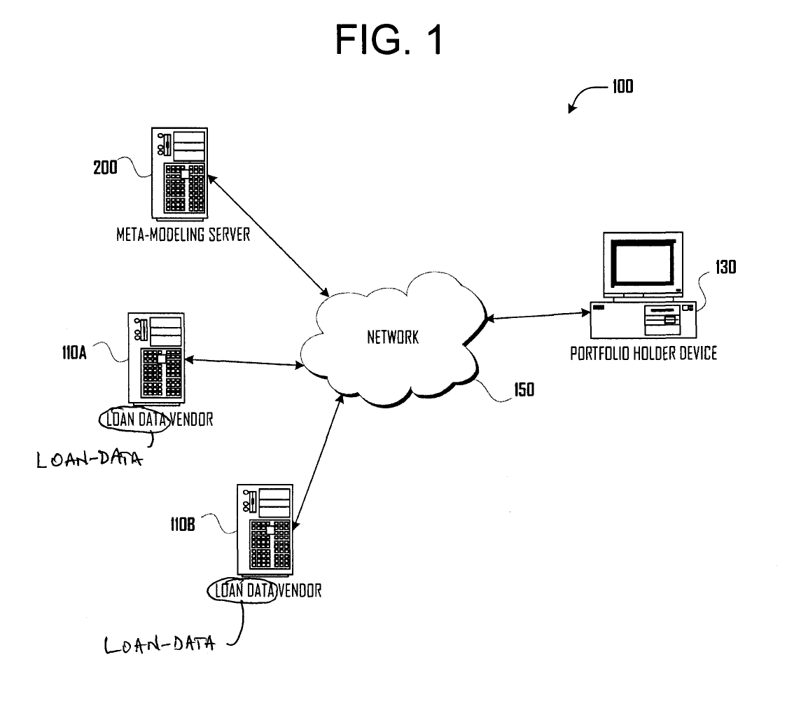

FIG. 1 illustrates an example of a network in accordance with one embodiment. Loan-data vendors 110A and 1106, portfolio holder device 130, and meta-modeling server 200 are connected to network 150. In various embodiments, network 150 comprises communication switching and routing capabilities. In various embodiments, network 150 may comprise some or all of the Internet, one or more intranets, and wired and/or wireless network portions. In various embodiments, there may be more than one portfolio holder device 130 and there may be additional loan-data vendors beyond vendors 110A and 1106. Moreover, while FIG. 1 shows a single meta-modeling server 200, in alternative embodiments, the functions, processes, and routines performed by meta-modeling server 200 could be hosted or distributed among two or more different devices. Many embodiments may use multiple devices to comprise one logical device—for example, when meta-modeling server 200 is executed or hosted in a “cloud computing” environment.

In various embodiments, loan-data vendors 110A and 1106 and/or portfolio holder device 130 may include any device that is capable of communicating with meta-modeling server 200, including desktop computers, laptop computers, mobile phones and other mobile devices, PDAs, set-top boxes, and the like.

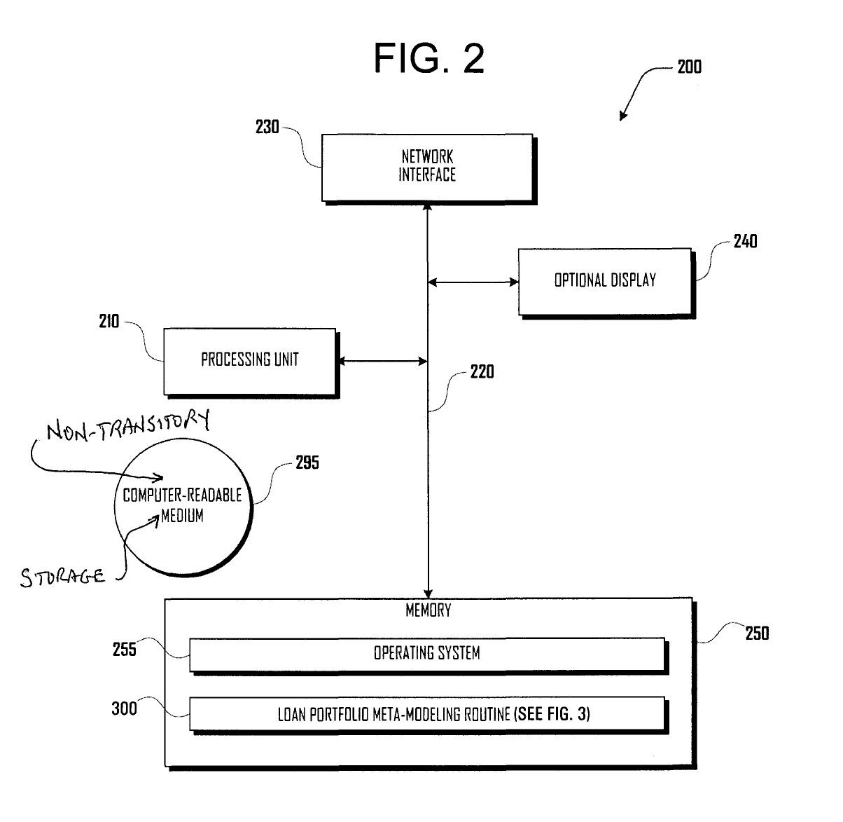

FIG. 2 illustrates an example of a meta-modeling server 200 in accordance with one embodiment. The example of FIG. 2 depicts a number of subsystems, modules, routines, and engines, some or all of which may by employed in a particular embodiment; the systems, modules, routines, and engines are not, however, limited to those illustrated. Other embodiments could be practiced in any number of logical software and physical hardware components and modules. The modules and components are listed herein merely for example.

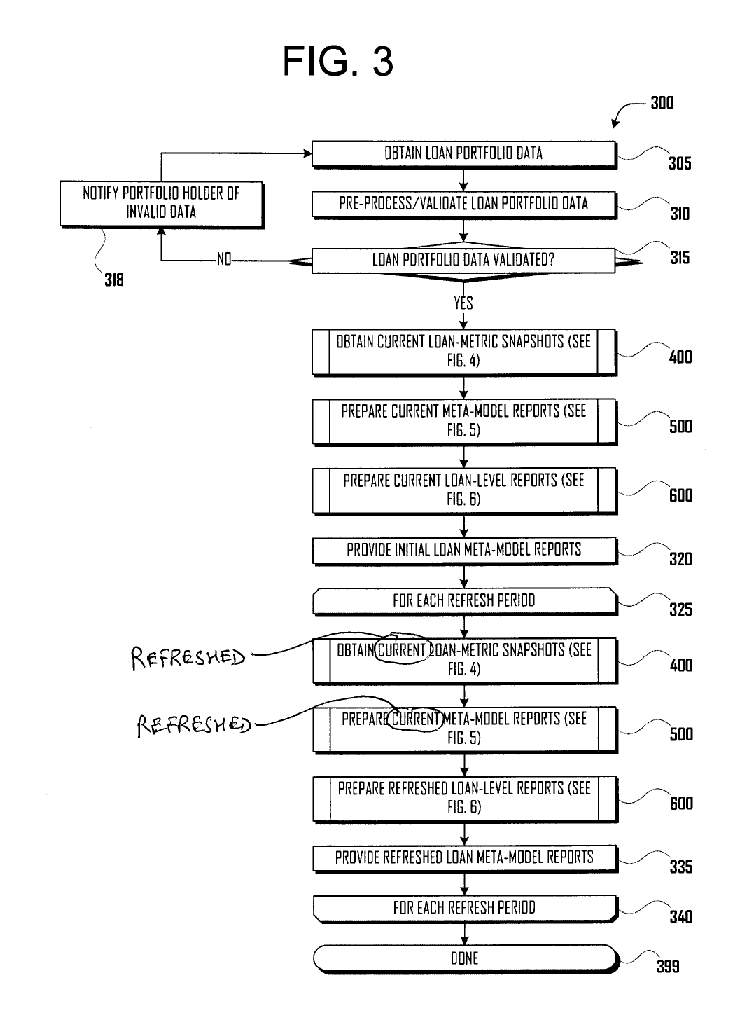

Meta-modeling server 200 includes a processing unit 210, a memory 250, and an optional display 240, all interconnected, along with network interface 230, via bus 220. Memory 250 generally comprises a random access memory (“RAM”), a read only memory (“ROM”), and/or a permanent mass storage device, such as a disk drive. In some embodiments, memory 250 may also comprise a local and/or remote database, database server, and/or database service. In other embodiments, network interface 230 and/or other database interface (not shown) may be used to communicate with a database (not shown). Memory 250 stores program code for a loan portfolio meta-modeling routine 300 (see FIG. 3, discussed below). In addition, memory 250 stores an operating system 255.

These and other software components may be loaded from a non-transitory computer-readable storage medium 295 into memory 250 of meta-modeling server 200 using a drive mechanism (not shown) associated with a computer-readable storage medium 295, such as a floppy disc, tape, DVD/CD-ROM drive, memory card. In some embodiments, software components may also be loaded via the network interface 230 or other transitory non-storage media.

FIG. 3 illustrates an example of a loan portfolio meta-modeling routine 300 in accordance with one embodiment that may be performed by meta-modeling server 200. For convenience of description, the loan portfolio meta-modeling routine 300 will be referred to as the LoanHD system, which is a proprietary loan management, real-time monitoring, analytics, and data refresh system developed by LoanHD, Inc. However, the loan portfolio meta-modeling routine 300 is not limited to any specific implementation, such as the LoanHD system, or to any particular version of the LoanHD system.

In block 305, the routine 300 obtains data corresponding to a loan portfolio data. For example, in one embodiment, the routine 300 may obtain (e.g., from portfolio holder device 130) a spreadsheet or other data file including information about individual mortgage making up a portfolio holder's portfolio. For example, information about an individual mortgage may include the address of the property, terms of the loan (interest rate, term, and the like), personally identifying information about one or more borrowers, and the like.

In block 310, the routine 300 pre-processes the loan portfolio data. For example, in one embodiment, the routine 300 may normalize a city, state, zip code, or other address field of loan data according to U.S. Postal Service standards. Moreover, in some embodiments, the routine 300 may analyze the loan portfolio data for inconsistent, incorrect, and/or missing information.

In block 315, the routine 300 determines whether the loan portfolio data includes invalid data or other data that would interfere with later steps in the process. If so, then in block 318, the routine 300 notifies the portfolio holder (e.g., portfolio holder device 130) that the loan portfolio data includes invalid data, giving the portfolio holder the opportunity to submit corrected loan portfolio data in block 305.

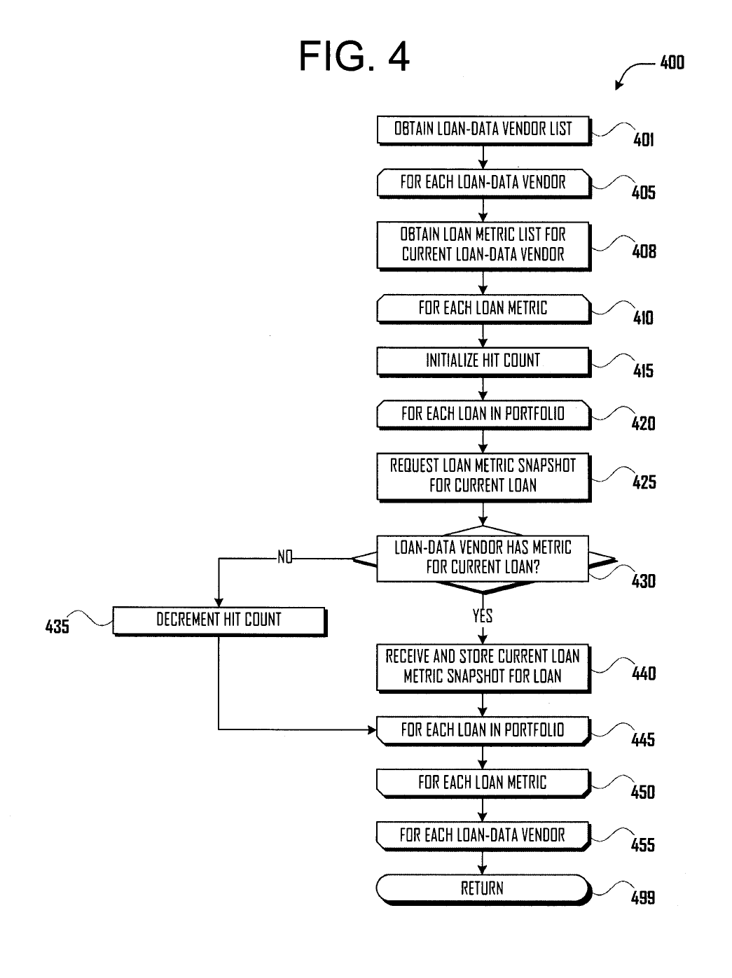

Otherwise, if the loan portfolio data is determined to be valid in block 315, in subroutine block 400 (see FIG. 4, discussed below), the routine 300 obtains a plurality of current “snapshots” from multiple vendors, each snapshot including a metric that its vendor deems to be relevant to some characteristic of a loan in the portfolio.

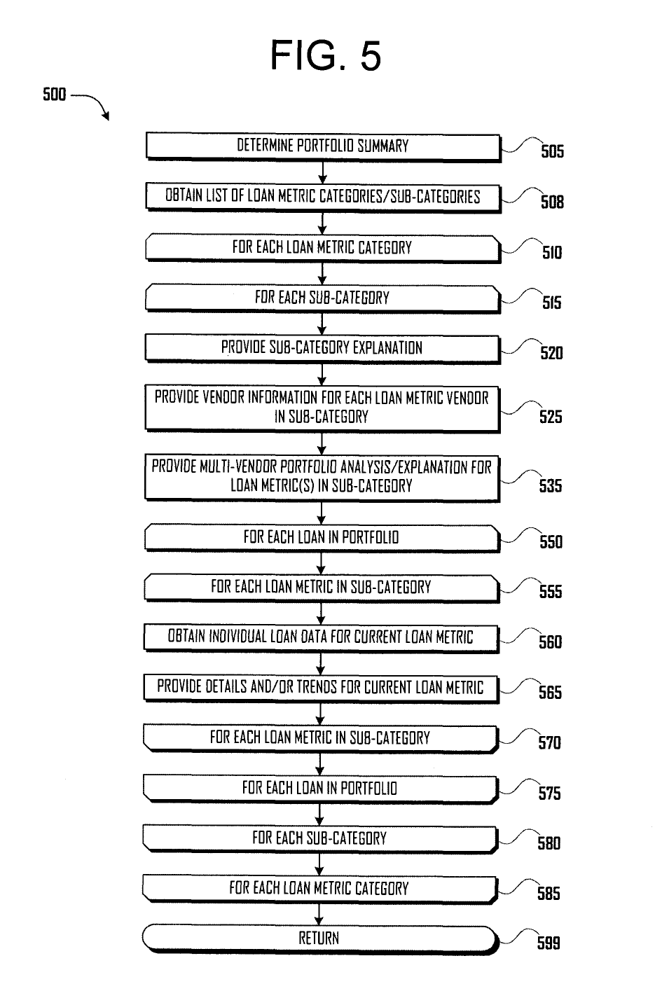

In subroutine block 500 (see FIG. 5, discussed below), the routine 300 prepares a plurality of current multi-vendor meta-model reports according to the current snapshots.

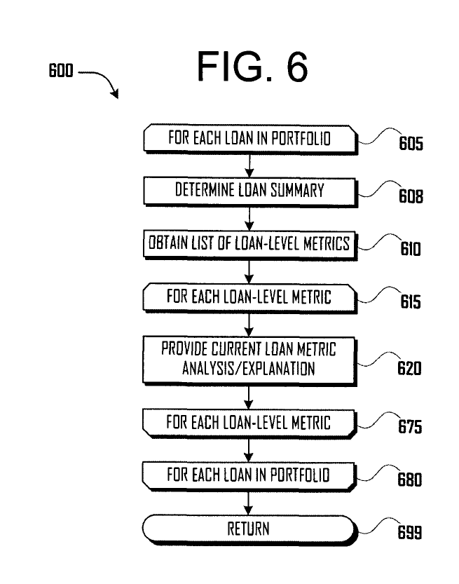

In subroutine block 600 (see FIG. 6, discussed below), the routine 300 prepares a plurality of current multi-vendor loan-level reports according to the current snapshots.

In block 320, the routine 300 provides the plurality of current multi-vendor loan meta-model reports to the loan holder. For example, in one embodiment, the routine 300 may provide the current multi-vendor loan meta-model reports for viewing via the World Wide Web.

Between opening loop block 325 and closing loop block 340, the routine 300 performs one or more periodic refreshes of the snapshots corresponding to the loan portfolio. For example, in some embodiments, the routine 300 may refresh snapshots for the loan portfolio after a refresh period of one or more weeks, months, quarters, or other suitable time period that may be determined by the loan holder.

During each refresh period routine 300 obtains a plurality of refreshed “snapshots” from multiple vendors in subroutine block 400; prepares a plurality of refreshed multivendor meta-model reports according to the refreshed snapshots in subroutine block 500; prepares a plurality of refreshed loan-level reports according to the refreshed snapshots in subroutine block 600; and provides the plurality of refreshed multi-vendor loan meta-model reports to the loan holder in block 335. For example, in one embodiment, the routine 300 may provide the refreshed multi-vendor loan meta-model reports for viewing via the World Wide Web.

In closing loop block 340, the routine 300 iterates back to opening block 325 if another refresh is to be performed, and if not, proceeds to block 399, where routine 300 ends.

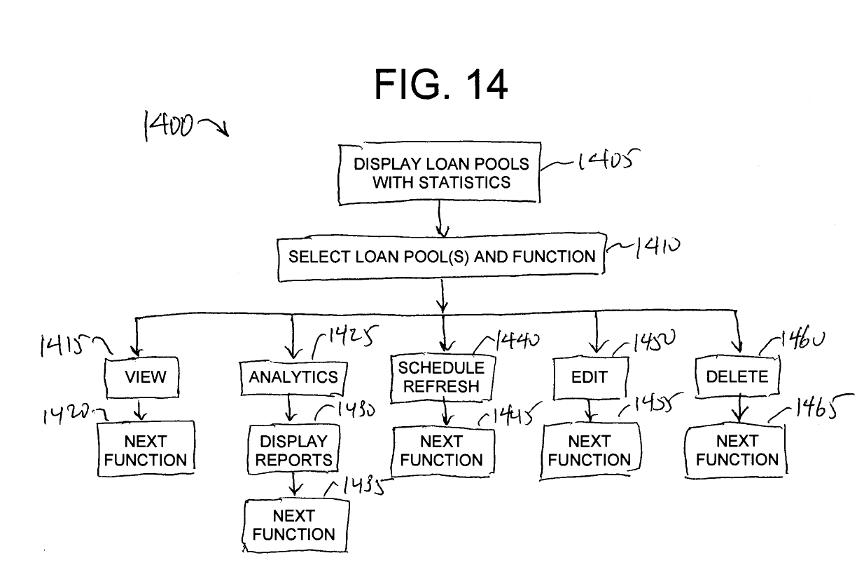

Although FIG. 3 shows performing the various operations for a loan portfolio, the various operations may be performed for one or more selected loan pools in the loan portfolio. Also, although subroutine blocks 500 in FIG. 3 show preparing the current meta-model reports and the refreshed meta-model reports for the entire loan portfolio, these reports may be prepared on demand for one or more selected loan pools in the loan portfolio as will be described below with respect to FIG. 14. Also, although subroutine block 600 in FIG. 3 show preparing the current loan-level reports and the refreshed loan-level reports for the entire loan portfolio, these reports may be prepared on demand for a selected loan in a selected loan pool in the loan portfolio as will be described below with respect to FIG. 14.

FIG. 4 illustrates an example of a subroutine 400 for obtaining a loan metric snapshot for a portfolio of loans at a particular point in time in accordance with one embodiment. In block 401, the subroutine 400 obtains a list of loan-data vendors. There are many loan-data vendors that are well known to one of ordinary skill in the art, and therefore specific loan-data vendors will not be described herein. Rather, for the purposes of this discussion, one example of loan-data vendors will be referred to as Credit Information Service, AVM (Automated Valuation Model) Service 1, AVM Service 2, AVM Service 3, Financial Profile Information Service, Predictive Analytics Service 1, Predictive Analytics Service 2, Loan Eligibility and Pricing Service, and Lien Information Service. However, other types of loan-data vendors and other combinations of loan-data vendors may also be used.

Additionally, in some embodiments, the subroutine 400 may obtain loan-related data from one or more governmental loan-data “vendors,” such as the United States Department of Commerce, the United States Internal Revenue Service, and the like.

Further descriptions of specific loan-data vendors may be found in the example reports shown in Appendices A and B of Provisional Application No. 61/467,747, which are incorporated herein by reference in their entirety.

Beginning in opening loop block 405, the subroutine 400 processes each loan-data vendor.

In block 408, the subroutine 400 obtains a list of one or more loan-related metrics that are provided by the current loan-data vendor. For example, in one embodiment, the list of loan-related metrics may include some or all of the following (for each list, the loan-data vendor is shown in parentheses): occupancy discrepancy ratio, non-owner occupied ratio, collateral validation, collateral liens, and the like (Lien Information Service); credit score(s), liabilities, mortgage debt, credit utilization, and the like (Credit Information Service); ability to pay, borrower income, and the like (Financial Profile Information Service); property valuation, collateral forecast, and the like (AVM Service 1); property valuation, and the like (AVM Service 2); delinquency forecast, prepayment forecast, loss severity forecast, cumulative loss, and the like (Predictive Analytics Service 1); risk of default, foreclosure frequency, loss severity forecast, cumulative loss, and the like (Predictive Analytics Service 2); loan eligibility, pricing, and the like (Loan Eligibility and Pricing Service), and intrinsic, retro, current, and future property valuations and the like (AVM Service 3). However, other loan-related metrics from the same or different loan-data vendors may be obtained.

Further descriptions of these and additional loan-related metrics may be found in the example reports shown in Appendices A and B of Provisional Application No. 61/467,747, which are incorporated herein by reference in their entirety.

Beginning in opening loop block 410, the subroutine 400 processes each loan-related metric provided by the current loan-data vendor. In block 415, the subroutine 400 initializes a “hit count” variable. In one embodiment, the “hit count” may be initialized to the number of loans in the loan portfolio.

Beginning in opening loop block 420, the subroutine 400 processes each loan in the loan portfolio. For clarity of illustration, an iterative embodiment is described that handles each loan/metric combination as a separate request. However, in other embodiments, data for multiple loans and/or for multiple metrics may be requested and/or obtained in batches from a loan-data vendor.

In block 425, the subroutine 400 requests from the current loan-data vendor a “snapshot” of the current loan's status with regard to the current metric as of a current or recent point in time. For example, in one embodiment, the subroutine 400 may request a credit score snapshot for one or more borrowers on the current loan, a property valuation snapshot for the current property, a delinquency forecast for the current loan, or the like.

In block 430, the subroutine 400 determines whether the loan-data vendor is able to provide the requested snapshot for the current loan. If not, then in block 435, the subroutine 400 decrements the “hit count” to indicate that the current loan-data vendor cannot provide the requested snapshot for the current loan, and then proceeds to closing loop block 445.

Otherwise, when the loan-data vendor is able to provide the requested snapshot for the current loan, then in block 440, the subroutine 400 receives the requested snapshot for the current loan and stores the snapshot (e.g., in a database) for later processing, and proceeds to closing loop block 445.

In closing loop block 445, the subroutine 400 iterates back to opening loop block 420 to process the next loan in the portfolio if there is one, and if not, proceeds to closing loop block 450.

In closing loop block 450, the subroutine 400 iterates back to opening loop block 410 to process the next loan metric provided by the current loan-data vendor if there is one, and if not, proceeds to closing loop block 455.

In closing loop block 455, the subroutine 400 iterates back to opening loop block 405 to process the next loan-data vendor if there is one, and if not, proceeds to block 499, where subroutine 400 ends.

FIG. 5 illustrates an example of a subroutine 500 for preparing a plurality of loan meta-model reports for a portfolio of loans in accordance with one embodiment, given a plurality of loan metric snapshots for loans in the portfolio.

In block 505, the subroutine 500 provides a summary or overview of the loan portfolio. For example, in one embodiment, the summary or overview may include components such as some or all of the following: a count of the loans making up the portfolio; a date of the last refresh of the various loan metric snapshots; a sum of the balances of the loans in the portfolio; an average (or other statistical measure) of coupons or rates associated with the loans in the portfolio; an average (or other statistical measure) of credit scores of borrowers associated with the loans in the portfolio; an average (or other statistical measure) of loan-to-value ratios (or similar measure) associated with the loans in the portfolio; an average (or other statistical measure) age of loans in the portfolio; an average (or other statistical measure) maturity of loans in the portfolio; a characterization of lien types associated with the loans in the portfolio; a characterization of the performance of the loans in the portfolio; and a characterization of the amortization of the loans in the portfolio. However, other components may also be included.

In some embodiments, such a portfolio summary and/or overview may be presented as part of some or all reports associated with the portfolio. See, e.g., the example reports shown in Appendix A of Provisional Application No. 61/467,747, which is incorporated herein by reference in its entirety.

In block 508, the subroutine 500 obtains a list of a plurality of loan metric categories, at least some of which may have two or more sub-categories. For example, in one embodiment, the list of loan metric categories and/or sub-categories may include some or all of the following (subcategories are listed parenthetically): Statistics (Origination, Product Group, Product Type, Loan Size, Coupon, Occupancy, Documentation, Seasoning, Amortization, Mortgage Insurance, and the like); Credit (FICO Score, VantageScore, Liability Meter, Mortgage Payment, Mortgage Credit, General Credit, Credit Accounts, and the like); Income (Income, Age, Ability to Pay Index, Income360, Income Movement, and the like); Collateral (LTV/CLTV, Value Analysis, Value Forecast, Collateral Integrity, Confidence Analysis, Collateral Validation, Property Type, Geographic Concentration, and the like); Liens (Silent Liens, Recorded Liens, Properties, and the like); Risk Models (Summary, Delinquency, Default, Prepayment, Loss Severity, Cumulative Loss, and the like); Valuation (Sale/Eligibility, Market Valuation, and the like); and Vendor Metrics (Vendor Metrics, and the like). However, other loan metric categories and/or sub-categories may be used.

Additional explanations of the sub-categories listed above may be found in Appendix A of Provisional Application No. 61/467,747, which is incorporated herein by reference in its entirety. In some embodiments, the list of loan metric categories and sub-categories may further include, for each sub-category, a listing of one or more loan metrics that are related to that category. Appendix A of Provisional Application No. 61/467,747, which is incorporated herein by reference in its entirety, also illustrates example groupings of loan metrics into particular sub-categories.

Beginning in opening loop block 510, the subroutine 500 processes each loan metric category. Beginning in opening loop block 515, the subroutine 500 processes each sub-category in the current loan metric category.

In block 520, the subroutine 500 obtains and provides an explanation of metrics included in the current sub-category. For example, as shown in Appendix A of Provisional Application No. 61/467,747, which is incorporated herein by reference in its entirety, for a Risk Models category Default sub-category, the subroutine 500 may obtain and provide a pre-written explanation, such as “For each loan in your portfolio, LoanHD provides the probability of involuntary termination due to inability to pay and the mortgage reaching foreclosure status. The Predictive Analytics Service 2 Foreclosure Frequency and the Predictive Analytics Service 1 Cumulative Default values represent the percentage of the loan balance that is at Risk. All values represent Life of Loan analysis.”

In block 525, the subroutine 500 obtains and provides vendor information associated with one or more loan-data vendors who provide metrics categorized in the current sub-category. For example, as shown in Appendix A of Provisional Application No. 61/467,747, which is incorporated herein by reference in its entirety, the subroutine 500 may obtain and provide one or more predetermined hyperlinks to one or more informational web pages provided by some or all of the vendors.

In block 535, the subroutine 500 provides multi-vendor portfolio-level analyses and explanations of one or more loan metrics in the current sub-category. For example, Appendix A of Provisional Application No. 61/467,747, which is incorporated herein by reference in its entirety, shows numerous examples of such multi-vendor portfolio-level analyses and explanations. In various embodiments, one or more charts, graphs, or other visual aids may be provided to illustrate, for example, some or all of the following: distributions of metric values across the loan portfolio (e.g., 75% of loans in the portfolio are current, 23% are terminated, 2% are delinquent to a degree); statistical measures of metric values across the loan portfolio (e.g., the weighted average of a foreclosure frequency metric across the portfolio is 19.71%); comparisons of similar metrics from different vendors (e.g., the weighted average of a first-vendor loss severity metric across the portfolio is 31.72%, whereas the weighted average of a second-vendor loss severity metric across the portfolio is 56.02%; changes in metric values over time (e.g., 2% of loans in the portfolio are delinquent as of one point in time, whereas 1% of loans were delinquent at a previous point in time); trends in changing metric values over time (e.g., loan delinquencies from a previous period to the current period are trending higher from a previous period to the current period, which is a negative trend; or the number of loans in the portfolio with second liens is trending lower from a previous period to the current period, which is a positive trend); and “hit counts” indicating a number or percentage of loans in the portfolio for which loan metrics in the current sub-category are available. However, other multi-vendor portfolio-level analyses and explanations may be provided.

Beginning in opening loop block 550, the subroutine 500 processes each loan in the loan portfolio. Beginning in opening loop block 555, the subroutine 500 processes each loan metric in the current sub-category. In block 560, the subroutine 500 obtains individual loan data for the current metric and the current loan. In some embodiments, the subroutine 500 may obtain a recent metric value and one or more past metric values for the current loan and the current metric. For example, if the current sub-category includes a credit score metric, the subroutine 500 may obtain a recent credit score value and zero or more past credit score values for the current loan.

In block 565, the subroutine 500 provides details and/or trends associated with the current metric and the current loan. In some embodiments, the subroutine 500 may further provide (or provide a link to) a loan-level detail report (see FIG. 6, discussed below) for the current loan. For example, in one embodiment, having obtained a recent and a past credit score value for the current loan in block 560, the subroutine 500 may present the recent credit score value and a trend indication, indicating whether, from a quantitative standpoint, the current metric is rising, falling, or remaining level from a distant point in time to a recent point in time. Subroutine 500 may further present an indication indicating whether a rising or falling quantitative trend is qualitatively positive or negative.

Appendix A of Provisional Application No. 61/467,747, which is incorporated herein by reference in its entirety, illustrates numerous examples of such detail and/or trend presentations. For example, recent credit score for a given loan may be presented alongside a trend indicator for that metric for that loan. In this example, a falling credit score quantitative trend may be qualitatively negative. In Appendix A of Provisional Application No. 61/467,747, which is incorporated herein by reference in its entirety, such a falling/negative trend may be indicated graphically via a down-pointing arrow (indicating quantitatively falling trend) colored red (indicating a qualitatively negative trend). For other metrics (e.g., delinquency forecast) a quantitatively falling trend may be qualitatively positive. Such a trend for such a metric may be indicated graphically by a down-pointing arrow colored green. Other embodiments may employ other trend/detail indicators.

In some cases, certain metric values or trends may trigger additional indicators if they fall above or below a pre-determined threshold. For example, if a recent loan-to-value metric for a given loan is greater then 100% (or is forecast to be greater than 100%), then a “negative equity” warning indication may be presented in association with that metric and that loan.

In closing loop block 570, the subroutine 500 iterates back to opening loop block 555 to process the next loan metric in the current sub-category if there is one, and if not, proceeds to closing loop block 575.

In closing loop block 575, the subroutine 500 iterates back to opening loop block 550 to process the next loan in the portfolio if there is one, and if not, proceeds to closing loop block 580.

In closing loop block 580, the subroutine 500 iterates back to opening loop block 515 to process the next sub-category in the current category if there is one, and if not, proceeds to closing loop block 585.

In closing loop block 585, the subroutine 500 iterates back to opening loop block 510 to process the next loan metric category if there is one, and if not, proceeds to block 599, where subroutine 500 ends.

Although FIG. 5 shows performing the various operations for each sub-category for each loan in an entire loan portfolio, the various operations may be performed on demand for a selected sub-category for each loan or selected loans in one or more selected loan pools in the loan portfolio as will be described below with respect to FIG. 14.

FIG. 6 illustrates an example of a subroutine 600 for preparing a plurality of multi-vendor loan-level reports for a portfolio of loans in accordance with one embodiment, given a plurality of loan metric snapshots for loans in the portfolio. See, e.g., the example loan-level report shown in Appendix B of Provisional Application No. 61/467,747, which is incorporated herein by reference in its entirety.

Beginning in opening loop block 605, the subroutine 600 processes each loan in the portfolio. In block 608, the subroutine 600 provides a summary or overview of the current loan. For example, in one embodiment, the summary or overview may include components such as some or all of the following: a class of the loan; an original balance of the loan; a current balance of the loan; a coupon rate of the loan; an origination date of the loan; a seasoning of the loan; a maturity of the loan; an amortization of the loan; a characterization of the loan's performance (e.g., current, terminated, delinquent, or the like); names and/or addresses of one or more borrowers associated with the loan; and a property address. However, the summary or overview may include other components.

In block 610, the subroutine 600 obtains a list of a plurality of metrics to be reported within a loan-level report. For example, in one embodiment, the list of loan metric categories and/or subcategories may include some or all of the following metrics: loan-to-value ratio, credit score(s), credit classification, credit utilization, borrower income assessment, collateral integrity, delinquency forecast(s), and the like. Additional loan-level metrics are illustrated in the example loan-level report provided in Appendix B of Provisional Application No. 61/467,747, which is incorporated herein by reference in its entirety. In some embodiments, some or all loan-level metrics may be grouped into sub-categories and/or categories.

Beginning in opening loop block 615, the subroutine 600 processes each loan-level metric. In block 620, the subroutine 600 obtains and provides an analysis and/or explanation of the current loan-level metric. For example, Appendix B of Provisional Application No. 61/467,747, which is incorporated herein by reference in its entirety, shows numerous examples of such loan-level metric analyses and explanations. In some embodiments, one or more similar or related metrics (e.g., credit scores from two different vendors) may be analyzed and/or explained in combination. In various embodiments, one or more charts, graphs, or other visual aids may be provided to illustrate, for example, some or all of the following: the loan's performance compared to a larger population according to a particular metric (e.g., the borrower's income compared to U.S. household incomes); breakouts of individual metric values for one or more co-borrowers (e.g., credit scores for each co-borrower); qualitative characterization of a particular loan metric value or combination or metric values (e.g., a loan whose borrower's credit scores are above a given threshold and whose loan-to-value ratio is below a given threshold may be characterized as “low risk”; a credit score above a given threshold may be characterized as “prime,” and the like); and trends in changing metric values over time (e.g., borrower credit scores from a previous period to the current period are trending higher from a previous period to the current period, which is a positive trend). However, other loan-level metrics may be analyzed or explained.

Appendix B of Provisional Application No. 61/467,747, which is incorporated herein by reference in its entirety, illustrates numerous examples of such analysis and/or explanation presentations. Additionally, in some embodiments, the subroutine 600 may obtain and provide a pre-written explanation or commentary associated with the current loan-level metric. For example, as illustrated in Appendix B of Provisional Application No. 61/467,747, which is incorporated herein by reference in its entirety, for a “Loss Severity” loan-level metric, the subroutine 600 may provide commentary such as “LoanHD provides an estimate of loss caused by the involuntary termination of loans. This estimate can help determine the amount of default-based loan loss. The value represents the percentage that is written-off if the loan defaults.”

In closing loop block 675, the subroutine 600 iterates back to opening loop block 615 to process the next loan-level metric if there is one, and if not, proceeds to closing loop block 680.

In closing loop block 680, the subroutine 600 iterates back to opening loop block 605 to process the next loan in the portfolio if there is one, and if not, proceeds to block 699, where subroutine 600 ends.

Although FIG. 6 shows performing the various operations for each loan in an entire loan portfolio, the various operations may be performed on demand for a selected loan in one or more selected loan pools in the loan portfolio as will be described below with respect to FIG. 14.

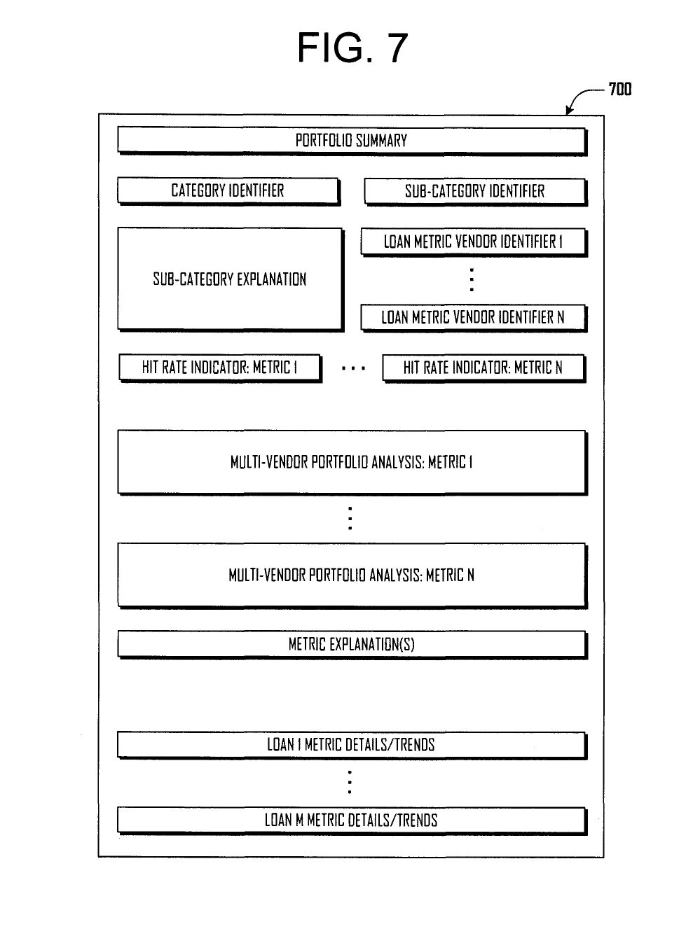

FIG. 7 illustrates an example of a generalized layout for a multi-vendor meta-model report for a given category and sub-category in accordance with one embodiment. Many of the example reports shown in Appendix A of Provisional Application No. 61/467,747, which is incorporated herein by reference in its entirety, follow a similar generalized layout. However, as will be apparent to one of ordinary skill in the art, the information in the multi-vendor meta-model report may be presented in many different formats.

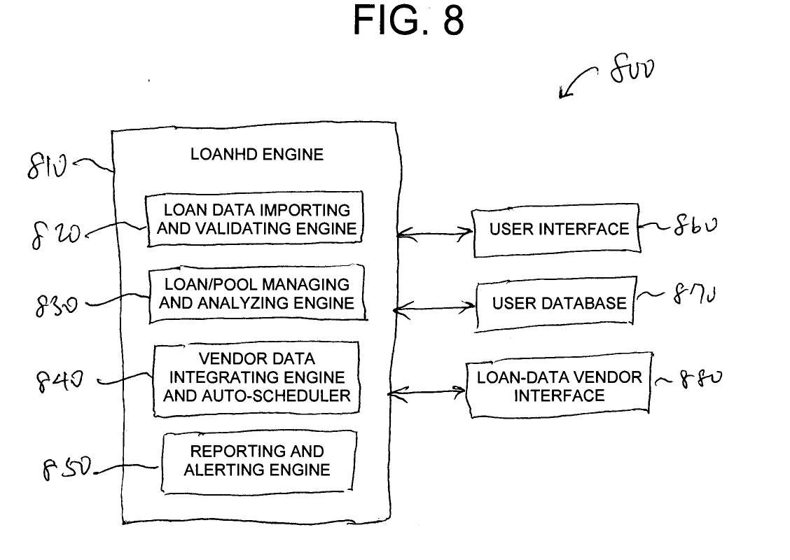

FIG. 8 illustrates an example of a LoanHD system 800 in accordance with one embodiment. The LoanHD system 800 includes a LoanHD engine 810, which is a loan portfolio meta-modeling system that operates on a meta-modeling server similar to the meta-modeling server 200 in FIG. 2, and may, for example, be implemented by a computer or a processor, such as the processor 210 in FIG. 2, performing a loan portfolio meta-modeling routine similar to the loan portfolio meta-modeling routine 300 in FIG. 2, but which may include additional features as described below. Computer instructions for controlling a computer or a processor to perform the loan portfolio meta-modeling routine to implement the LoanHD engine 810 may be stored on a non-transitory computer-readable storage medium, such as the non-transitory computer readable storage medium 295 in FIG. 2, and may be loaded into a memory, such as the memory 250 in FIG. 2 in which the operating system 255 is stored, from the computer-readable storage medium.

The LoanHD engine 810 includes a loan data importing and validating engine 820, a loan/pool managing and analyzing engine 830, a vendor data integrating engine and auto-scheduler 840, and a reporting and alerting engine 850. The LoanHD system 800 also includes a user interface 860, a user database 870, and a loan-data vendor interface 880.

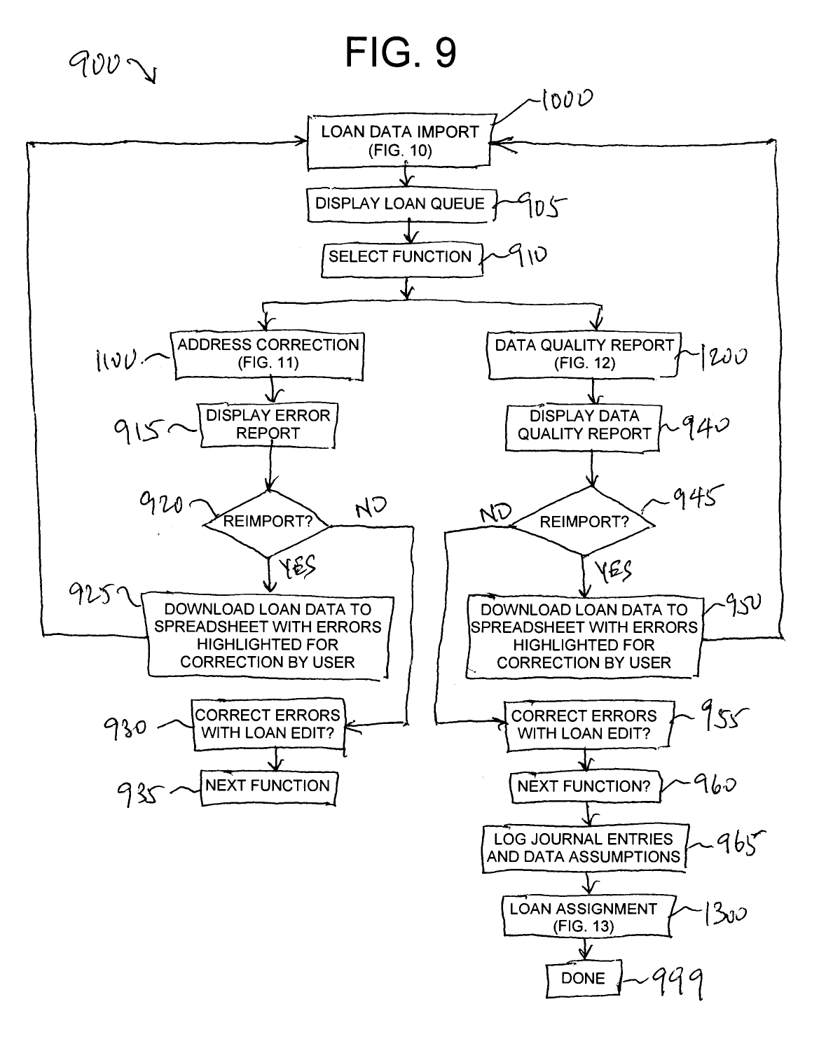

The loan data importing and validating engine 820 enables a user to import and validate loan data, and may, as an example, perform the operations in blocks 305, 310, 315, and 318 in FIG. 3, or may perform the loan data importing and validating routine 900 in FIG. 9.

More specifically, the loan data importing and validating engine 820 imports loans to a data mapping queue, allows the mapping of user-defined fields to LoanHD fields, saves mapping templates, cleanses data for proper field format (such as MM/DD/YYYY for date of birth), imports loans into the loan queue, performs address correction and data quality reporting, creates new loan pools or adds loans to existing loan pools, edits loan level data, and deletes loans and loan pools.

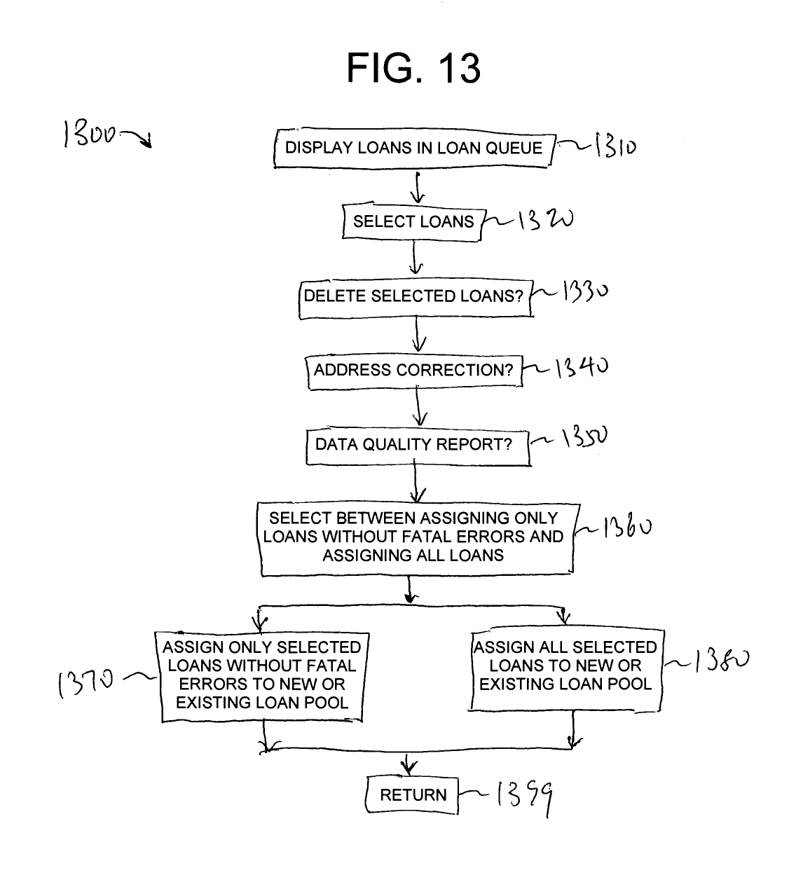

The loan/pool managing and analyzing engine 830 enables a user to create new loan pools, manage existing loan pools by adding or deleting loans, and delete existing loan pools. The loan/pool managing and analyzing engine 830 also enables a user to schedule when loan-data vendor services are to be run for selected loan pools to obtain new vendor loan data or refresh existing vendor loan data. The vendor loan data may be, for example, the loan metrics that are obtained by the subroutine 400 in FIG. 4 as described above. The loan/pool managing and analyzing engine 830 also enables a user to selectively display pre-defined and/or custom pool-level reports for one or more selected loan pools and pre-defined loan-level reports for loans in one or more selected loan pools. The loan/pool managing and analyzing engine 830 may, for example, perform the loan/pool managing and analyzing routine 1300 in FIG. 13.

More specifically, the loan/pool managing and analyzing engine 830 creates new loan pools, manages existing loan pools by adding and deleting loans, deletes existing loan pools, schedules loan-data vendor services, performs analysis to display analytic reports (or pages or views), and performs data quality reporting by vendor, service, or a custom combination.

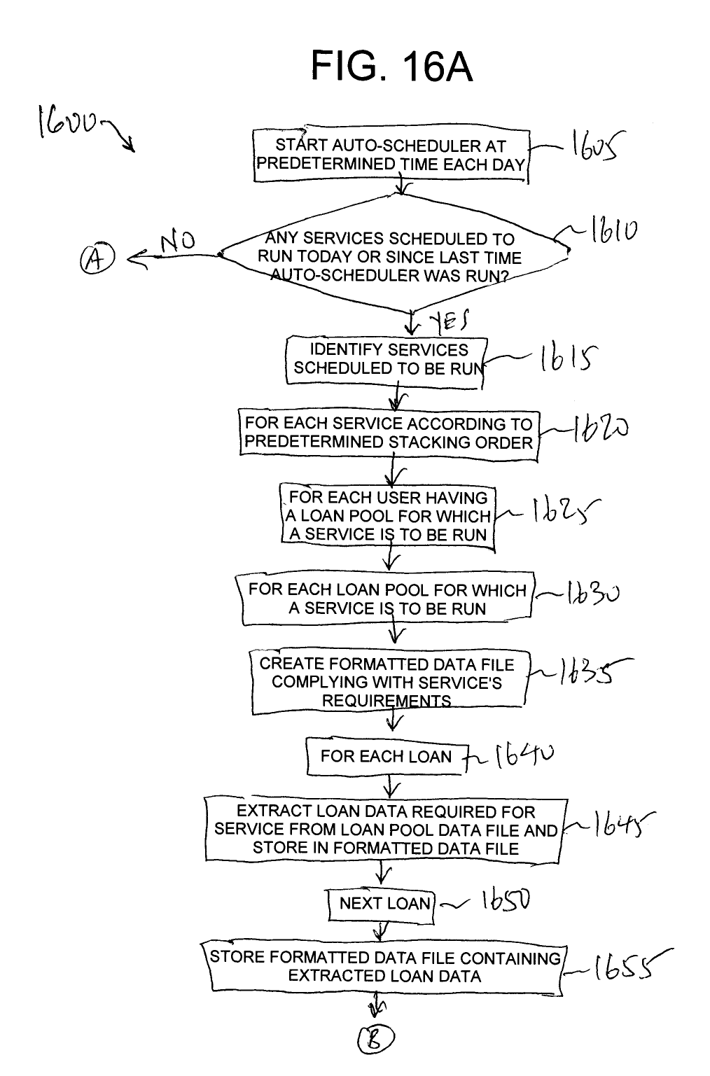

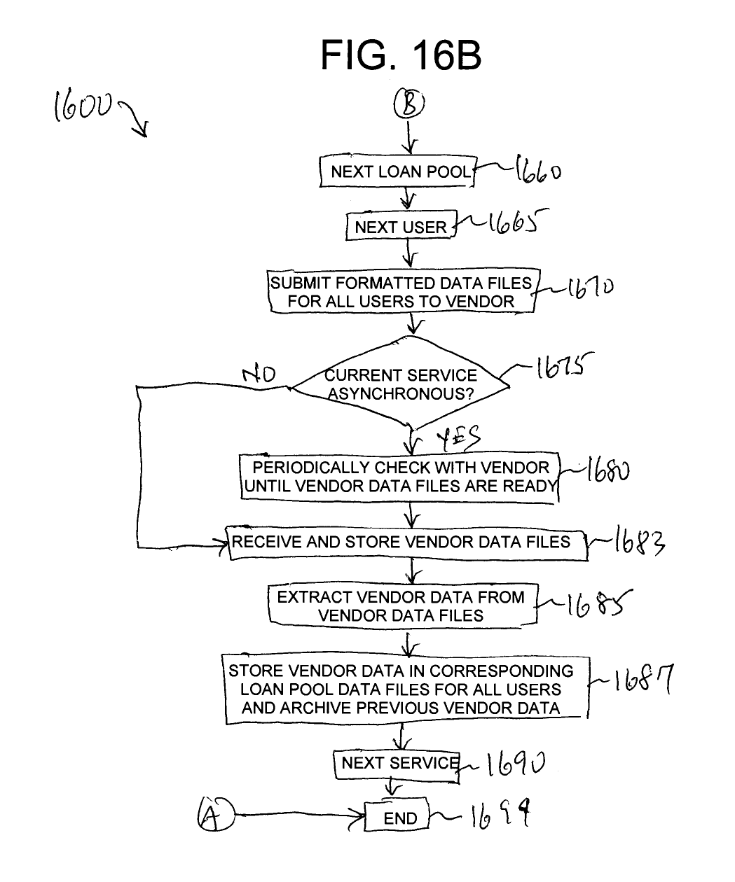

The vendor data integrating engine and auto-scheduler 840 automatically runs the loan-data vendor services for all loan pools for all users for which the services are to be run at the scheduled times, and may perform the subroutine 400 in FIG. 4, or may perform the vendor data integrating and auto-scheduling routine 1600 in FIGS. 16A and 16B.

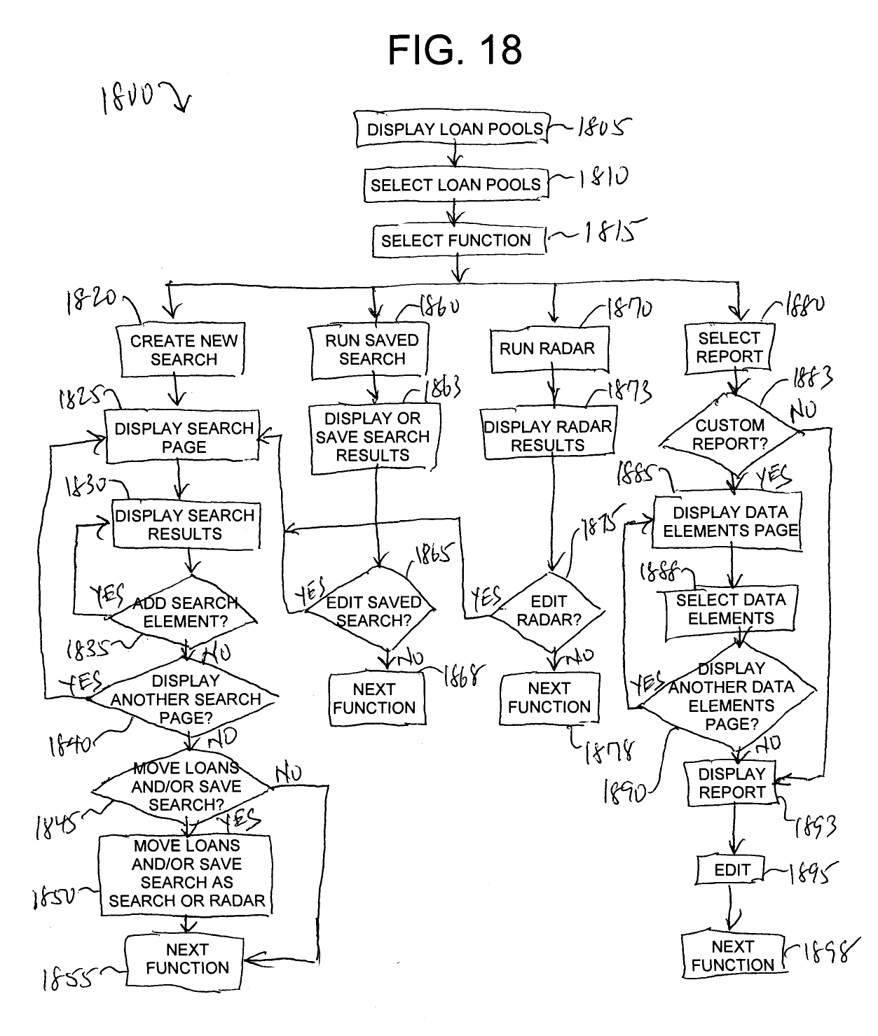

The reporting and alerting engine 850 enables a user to create searches by specifying exactly which search elements are to be included in the search, apply the searches to selected loan pools, save the searches for future use, and save the searches as Radars to alert the user if certain conditions are met the next time the Radar is run. The reporting and alerting engine 850 also enables the user to produce a variety of loan reports, such as the loan meta-model reports that are produced by the subroutine 500 in FIG. 5, examples of which are shown in Appendix A of Provisional Application No. 61/467,747, which is incorporated herein by reference in its entirety; the multi-vendor loan-level reports that are produced by the subroutine 600 in FIG. 6, examples of which are shown in Appendix B of Provisional Application No. 61/467,747, which is incorporated herein by reference in its entirety; and the reports that are produced by the reporting routine 1800 in FIG. 18, which include custom reports where the user specifies exactly which data elements are to be included in the custom reports. The reporting and alerting engine 850 may perform the subroutine 500 in FIG. 5 and the subroutine 600 in FIG. 6, or may perform the reporting routine 1800 in FIG. 18.

The user interface 860 enables a user using, for example, a portfolio holder device such as the portfolio holder device 130 in FIG. 1, to interface with the LoanHD engine 810 via a network, such as the network 150 in FIG. 1, and may correspond to the network interface 230 in FIG. 2. The user interface 860 may use any suitable type of network connection, such as HTTP, HTTPS, FTP, FTPS, and the like.

The user database 870 stores the loan data uploaded by each user, and the vendor loan data that was obtained each time any of the loan-data vendor services were run for any of users' loans. The user database 870 segregates the data by user so that each user can only access the user's own data. The user database 870 may be stored in a memory, such as the memory 250 in FIG. 2 in which the operating system 255 and the loan portfolio meta-modeling routine 300 are stored, or may be stored in a hard disk drive or any other suitable storage device that is known in the art, with optional memory caching.

The loan-data vendor interface 880 enables the LoanHD engine 810 to interface with various loan-data vendors, such as the loan-data vendors 110A and 110B in FIG. 1 and the various specific loan-data vendors described above, via a network, such as the network 150 in FIG. 1, and may correspond to the network interface 230 in FIG. 2. The loan-data vendor interface 880 may use any suitable type of network connection, such as HTTP, HTTPS, FTP, FTPS, and the like.

FIG. 9 illustrates an example of a loan data importing and validating routine 900 that is an alternate version of blocks 305, 310, 315, and 318 in FIG. 3, and is performed by the loan data importing and validating engine 820 in FIG. 8.

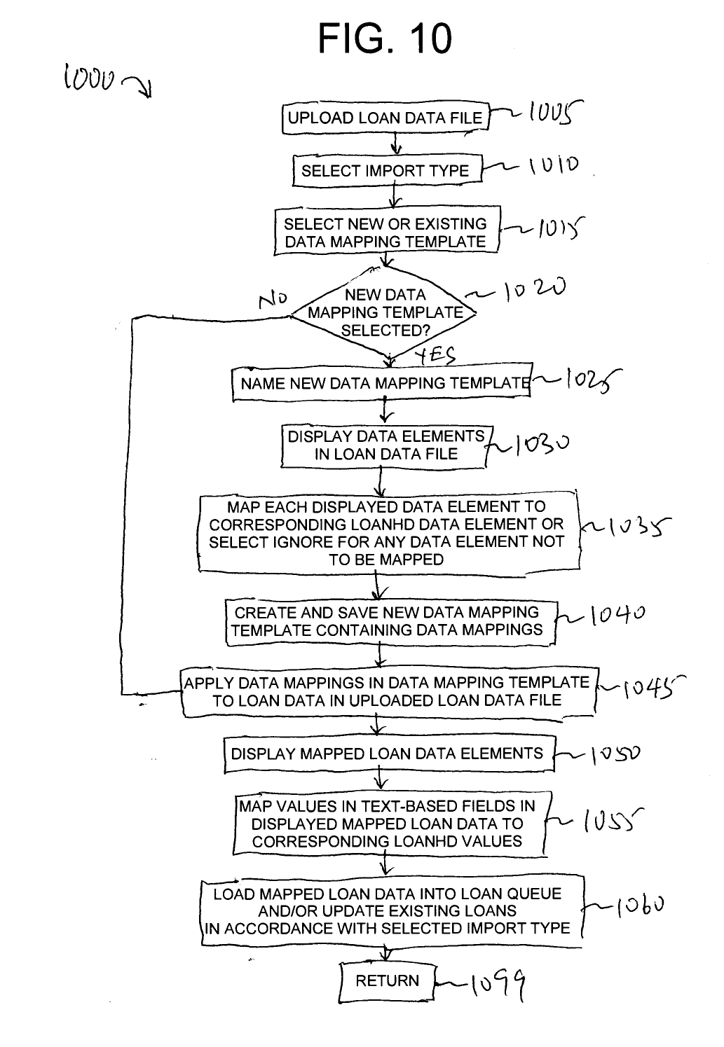

Block 1000 is a loan data import subroutine that the routine 900 uses to import a user's loan data. An example of the loan data import subroutine is illustrated in FIG. 10.

In block 905, the routine 905 displays a loan queue, which is a holding place for loans that have not yet been assigned to a loan pool. The loan queue will be described in greater detail with respect to FIG. 10.

In block 910, the routine 900 selects a function in response to an instruction from the user. The functions that can be selected are address correction and data quality report. The routine may enable the user to select a function by displaying buttons that the user can click to select a function. However, as will be apparent to one of ordinary skill in the art, other techniques may be used to enable the user to select a function.

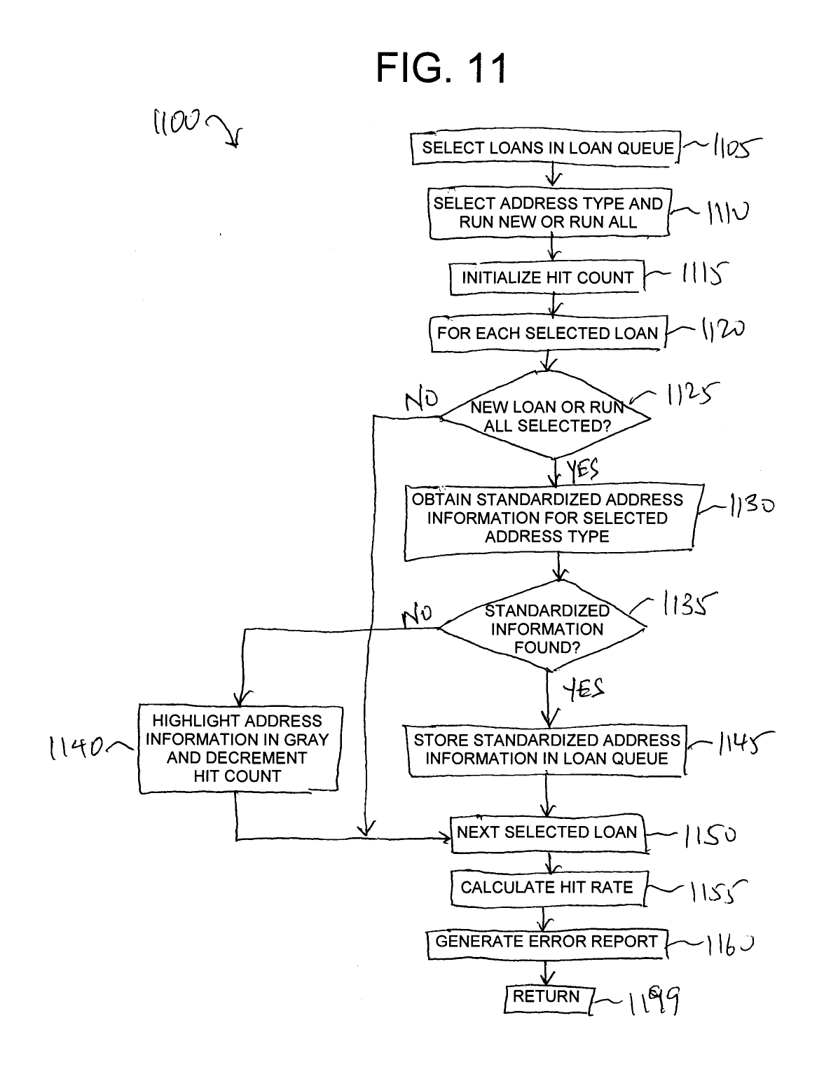

In block 1100, the routine 900 runs an address correction subroutine to automatically correct address errors in the loan data in the loan queue in response to the user selecting address correction in block 905, and to highlight various errors in the loan data. An example of the address correction subroutine 1100 is illustrated in FIG. 11.

In block 915, the routine 900 displays an error report and a “hit rate” generated by the address correction subroutine 1100 as described below in connection with FIG. 11 in response to an instruction from the user.

In block 920, the routine 900 determines whether the user wants to correct address errors in the loan data in the loan queue and reimport the corrected loan data in response to an instruction from the user. If yes, the routine 900 proceeds to block 925. If no, the routine 900 proceeds to block 930.

In block 925, the routine 900 downloads the loan data to a spreadsheet with address errors highlighted in gray as described below in connection with FIG. 11 to enable to the user to correct the errors, and then returns to the loan data import subroutine 1000 to enable the user to reimport the corrected loan data.

In block 930, the routine 900 determines whether the user wants to correct address errors in the loan data in the loan queue using a loan edit function in response to an instruction from the user. The loan edit function may enable the user to edit the loan data without having to then reimport the loan data through the loan data import subroutine 1000 by enabling the user to point to a LoanID displayed as a link in the error report using a mouse or other pointing device to display a pop-window listing Loan ID, Ext. ID, borrower name, co-borrower name, and a selection Loan Data: Edit. The word Edit may be a LinkButton that when clicked will display a pop-up window listing the loan data for the loan having the Loan ID and enabling the user to edit the loan data using text boxes, drop-down boxes, radio buttons, etc. The pop-up window also includes a Save button that the user can click on to save the changes. Loan ID is an internal loan identifier assigned to the loan by the LoanHD system, and Ext. ID is the user's loan identifier. LoanHD system makes the loan edit function available anywhere a LoanID is displayed. However, as will be apparent to one of ordinary skill in the art, other techniques may be used to enable the user to select the loan edit function and/or edit the loan data. The routine 900 remains at block 930 to allow the user to correct errors using the loan edit function until the routine 900 determines that the user is done correcting errors, or determines that the user does not want to correct any errors. The routine then proceeds to block 935.

In block 935, the routine 900 returns to block 910 to enable the user to select another function.

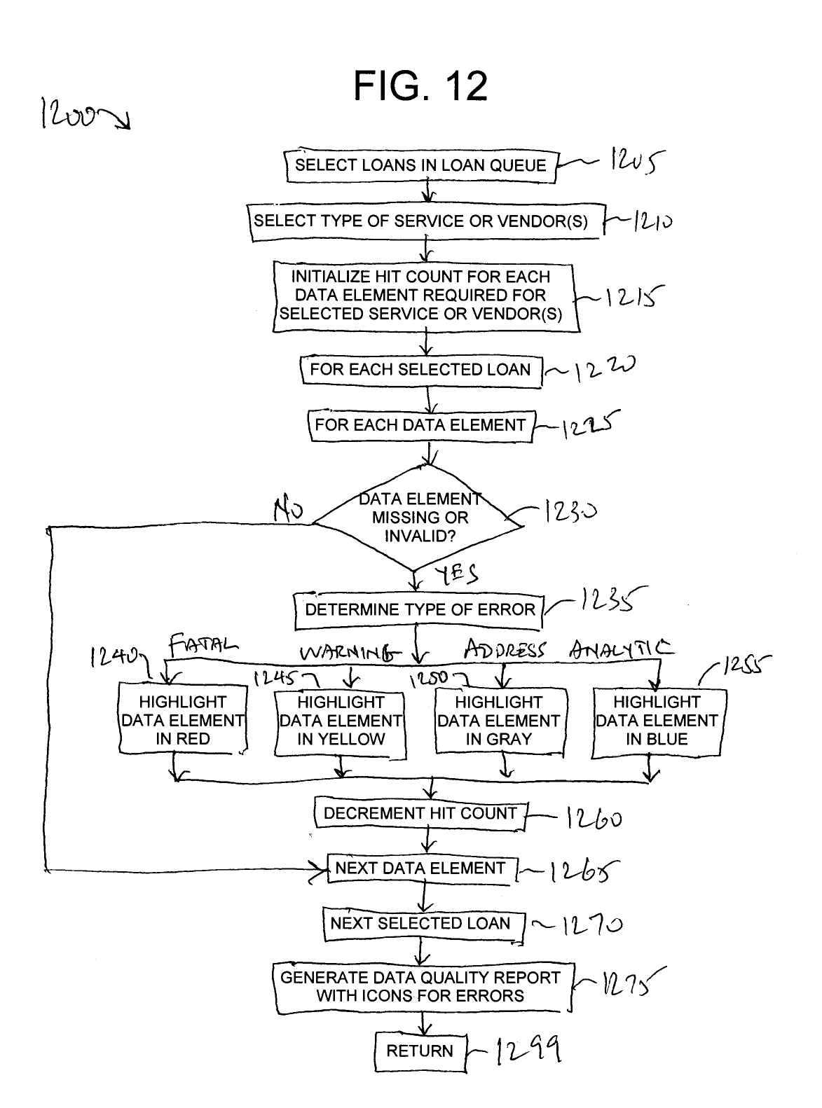

In block 1200 the routine 900 runs a data quality report subroutine that the routine 900 uses to identify errors in the loan data in the loan queue that will make it impossible to run various loan-data vendor services; are necessary to obtain vendor loan data from a loan-data vendor; are missing address information; and are necessary to display certain charts, graphs, data tables, data analyses, trends, or other analytics on reports such as those described above and shown in Appendices A and B of Provisional Application No. 61/467,747, which are incorporated herein by reference in their entirety. The data quality report subroutine 1200 also highlights the errors in the loan data in red, yellow, gray, and blue as described below in connection with FIG. 12

In block 940, the routine 900 displays a data quality report generated by the data quality report subroutine 1200 as described below in connection with FIG. 12 in response to an instruction from the user.

In block 945, the routine 900 determines whether the user wants to manually correct errors in the loan data in the loan queue and reimport the corrected loan data in response to an instruction from the user. If yes, the routine 900 proceeds to block 950 in which the routine downloads the loan data to a spreadsheet with the errors highlighted in red, yellow, gray, and blue referred to above and described below in connection with FIG. 12 to enable to the user to correct the errors, and then returns to the loan data import subroutine 1000 to enable the user to reimport the corrected loan data as described above. If no, the routine 900 proceeds to block 955.

In block 955, the routine 900 determines whether the user wants to correct errors in the loan data in the loan queue using a loan edit function in response to an instruction from the user. The loan edit function was described in detail above in connection with block 930. The routine 900 remains at block 955 to allow the user to correct errors using the loan edit function until the routine 900 determines that the user is done correcting errors, or determines that the user does not want to correct any errors. The routine then proceeds to block 960.

In block 960, the routine 900 either returns to block 910 to enable the user to select another function or proceeds to block 965 in response to an instruction from the user.

The user will typically run the address correction subroutine 1100 before running the data quality report subroutine 1200, but this is not required. The advantage of running the address correction subroutine 1100 first is that the address correction subroutine 1100 can automatically provide some of the missing address information that would be identified by the data quality report subroutine 1200 if the data quality report subroutine 1200 were to be run first, such as the Zip code or the add-on code for Zip+4, thereby avoiding the need for the user to correct some of the missing address information identified by the data quality report subroutine 1200.

The user may continue running the address correction subroutine 1100 and the data quality report subroutine 1200 and making corrections to the loan data in the loan queue as described above until all errors have been corrected or the user has chosen to ignore any remaining errors.

In block 965, the routine 900 logs journal entries and data assumptions in response to instructions from the user. The journal entries and data assumptions are optional. A journal entry is a note that is applied to one or more loans, while a data assumption is a note that is applied to one or more loans and to one or more specific pages of data or reports for the one or more loans that are displayed by the reporting and alerting engine 850 as will be described below. Examples of notes that might be applied by the journal entries and data assumptions might be “no income information captured in servicing platform,” “all condo loans mapped as condo 1-4 story,” and “no self-employment data available.” This provides greater transparency to anyone reviewing the user's loan data because the assumptions on which the loan data is based is readily available to the reviewer.

The routine 900 may enable the user to log the journal entries and data assumptions by displaying a journal entry ticket that the user may use to enter the relevant data. For example, the journal entry ticket may display a list of the loans in the loan data in the loan queue with a checkbox by each loan to enable it to be selected and a checkbox at the top of the list to enable all of the loans to be selected.

To enable the user to log a journal entry, the journal entry ticket might provide fields for the user to enter a journal date, an issue owner (the person or organization responsible for the issue that prompted the assumption), a description of the issue, and a resolved date, and might enable the user to attach a file relating to the issue.

To enable the user to log a data assumption, the journal entry ticket might also provide a data assumption checkbox that when checked by the user, causes the journal entry ticket to provide different fields than those used to log a journal entry. For example, the journal entry ticket when used to log a data assumption might provide fields for the user to enter an entry date, the name of the person who made the entry, the name of the person who approved the entry, and a description of the assumption, and might display a pop-up list of the names of the pages of data to which the data assumption can be applied. The user can select one or more of the pages of data to which the user wants the data assumption to be applied.

However, as will be apparent to one of ordinary skill in the art, the routine 900 may use other techniques to enable the user to log the journal entries and the data assumptions.

The routine 900 remains at block 965 to allow the user to log journal entries and data assumptions until the routine 900 determines that the user is done logging journal entries and data assumptions, or determines that the user does not want to log any journal entries and data assumptions. The routine then proceeds to block 1300.

In block 1300, the routine 900 runs a loan assignment subroutine that enables the user to assign loans in the loan queue to loan pools. An example of the loan assignment subroutine 1300 is illustrated in FIG. 13. When the subroutine 1300 is finished, the routine 900 proceeds to block 999, where the routine 900 ends.

FIG. 10 illustrates an example of the loan data import subroutine 1000 shown in FIG. 10. In block 1005, the subroutine 1000 uploads a loan data file prepared by the user containing data elements for one or more loans in response to an instruction from the user. The loan data file is preferably a Microsoft Excel data file in which each row corresponds to one loan, and each column corresponds to one data element. However, as will be apparent to one of ordinary skill in the art, the system may be modified to accept a loan data file in other formats. The user may obtain the loan data for the loan data file by exporting the loan data from the user's loan origination system and/or loan servicing platform, and/or by manually entering loan data into the loan data file. The data elements in the loan data file may be arranged in any order that is convenient for the user.

Which data elements are included in the loan data file may depend on the type of service the user desires to use. Examples of services that the LoanHD system 800 makes available to the user may include Credit and Income Service; Credit, Income, and Collateral Service; and Full Analytics Service. Each of these services requires certain data elements to obtain vendor loan data from loan-data vendors. However, other services may be made available to the user.

Examples of data elements that may be required for the Credit and Income Service may include User's Loan Number (File Number) (required for every upload); Borrower First Name; Borrower Middle Initial; Borrower Last Name; Borrower Social Security Number; Borrower Mailing Address Street; Borrower Mailing Address City; Borrower Mailing Address State; Borrower Mailing Address Postal Code; Borrower Date of Birth; Co-Borrower First Name; Co-Borrower Middle Name; Co-Borrower Last Name; Co-Borrower Social Security Number; Co-Borrower Mailing Address Street; Co-Borrower Mailing Address City; Co-Borrower Mailing Address State; Co-Borrower Mailing Address Postal Code; Current Loan Amount; Loan Category Type (for example, Mortgage, Auto, Credit Card, Student, or Other); Borrower FICO Original; and Co-Borrower FICO Original.

There may be other data elements that may be optional for the Credit and Income Service, but may be needed to perform certain analytics and display certain information on reports such as those described above and shown in Appendices A and B of Provisional Application No. 61/467,747, which are incorporated herein by reference in their entirety. Such optional data elements may include Borrower Monthly Wage Income; Borrower Self Employment Indicator (for example, 0 if not self-employed, 1 if self-employed); Co-Borrower DOB; Co-Borrower Monthly Wage Income; Co-Borrower Self Employment Indicator; URLA (Universal Residential Loan Application) Total Monthly Income Amount; Current Payment Status (for example, options may be Current; 30 Days Late; 60 Days Late; 90 Days Late; 120 Days Late; 180 Days Late; Closed—Paid Off; Closed—Charged Off; Closed—Refinanced; Foreclosed; Unknown); Delinquency History (for example, most recent 12 months pay history) (for example, options may be 0=Current; 1=30-59 days delinquent; 2=60-89 days delinquent; 3=90-119 days delinquent; 4=120+ days delinquent; 5=Foreclosure; 6=REO; 7=Loan did not exist in period; X=Unavailable); Delinquent Payments Over Past Twelve Months Count; times payment has been 30 days late in past 12 months; times payment has been 60 days late in past 12 months; times payment has been 90 days late in past 12 months; Loan Modification Indicator (for example, 0 if no, 1 if yes); Loan Modification Date; Loan Modification Reason (for example, Loss Mitigation—troubled debt restructures; Retention—borrower contacted the lender with a better financing offer from a third party or the lender solicited the borrower as a portfolio-retention strategy; Portfolio Management Strategy—portfolio lenders modify non-GSE (government-sponsored enterprise) eligible loans into GSE eligible loans for capital relief or as a risk transfer; Other); and Loan Modification Type (for example, 1=Rate Reduction—the interest rate on the mortgage was lowered to reduce borrower payments; 2=Term—a term modification is one in which there was a change to the rate reset date balloon feature and maturity date; 3=Principal Write-Down—a modification where an adjustment to the unpaid principal balance was the only modified term of the mortgage; 4=Capitalization—where accrued and/or deferred principal, interest, servicing advances, expenses, fees, etc. are capitalized into the unpaid principal balance of the modified loan; 5=FDIC Streamline; 6=Proprietary Other).

Examples of data elements that may be required for the Credit, Income, and Collateral Service may include all of the data elements required for the Credit and Income Service, plus Origination Date (or First Payment Date); Lien Position (for example, First, Second, Third); Original Loan Amount; Property Type (for example, 1 Family; Condo 1-4 Story; Condo 5-8 Story; Condo 9+Story; Coop; PUDs; 2 Family; 3 Family; 4 Family; Townhouse; Manufactured; Condotel; Mobile Home; Land & Development; Other); Occupancy (for example, Primary Residence, Second Home, Investment Property); Property Address Street; Property Address City; Property Address State; Property Address Postal Code; Original Property Value/Purchase Price; Original Property Valuation Date; and HELOC (home equity line of credit) High Credit Limit (HELOCs only).

There may be other data elements that may be optional for the Credit, Income, and Collateral Service, but may be needed to perform certain analytics and display certain information on reports such as those described above and shown in Appendices A and B of Provisional Application No. 61/467,747, which are incorporated herein by reference in their entirety. Such optional data elements may include all of the data elements that are optional for the Credit and Income Service.

Examples of data elements that may be required for the Full Analytics Service may include all of the data elements required for the Credit, Income, and Collateral Service, plus Documentation (for example, Full Doc—the borrower provided full verification of income levels via W2, pay stubs, tax returns, etc.; No Income/No Asset—the borrower did not disclose any income or assets on the application at the time of origination; No Income/Verified Assets—the borrower did not disclose any amount of income on the application but provided documentation to verify assets; Stated Income/No Assets; Stated Income/Stated Assets—the borrower stated income and assets on the application and did not provide documents to verify; Stated Income/Verified Assets—the borrower stated income on the application and did not provide documents to verify but provided documentation to verify assets; Verified Income/No Assets; Verified Income/Stated Assets; Unknown); Mortgage Type (for example, Conventional; FHA; VA; HELOC; Other); Loan Purpose (for example, Purchase; Rate/Term Refinance; Cash Out Refinance; Construction/Perm; Construction; Other); Amortization Type (for example, Fixed; Adjustable; Original); Amortization Term; Current Amortization Term; Interest Only Indicator (for example, 0=No, 1=Yes); Interest Only Term (for example, >=0 and <=240; blank=No Interest Only Term); Original Interest Rate; Current Interest Rate; Product Group (for example, 1=FNMA—serviced mortgages that are owned by FNMA; 2=FHLMC—serviced mortgages that are owned by FHLMC; 3=GNMA—serviced mortgages that are owned by GNMA; 4=Private—loan securitized by private-label (non-government, non-GSE) issuers; 5=Portfolio—mortgage owned and held on the bank's/credit union's balance sheet, including both Held for Sale or Held for Investment); Product Type (see below for examples); Balloon Indicator (for example, 0=No, 1=Yes); Mortgage Insurance Indicator (for example, 0=No, 1=Yes); Mortgage Insurance Company Name (see below for examples); Mortgage Insurance Percent (for example, 1 Yr T-Bill; 2 Yr T-Bill; 3 Yr T-Bill; 1 Yr Libor; 6 Mth Libor; COFI; 1 Mth Libor; MTA; 1 Mth MTA; 6 Mth T-Bill; 1 Yr CMT; Prime); Gross Margin; Initial Fixed Rate Period (months); Initial Interest Rate Cap; Lifetime Interest Rate Cap; Subsequent Interest Rate Adjustment Period (months); Subsequent Interest Rate Cap (Periodic Cap); Subsequent Interest Rate Cap (Periodic Floor); Lifetime Maximum Rate (Ceiling); Lifetime Minimum Rate (Floor); Negative Amortization Indicator (for example, 0=No, 1=Yes); Negative Amortization Limit; Initial Negative Amortization Recast Period (months); Subsequent Negative Amortization Recast Period (months); Subsequent Payment Reset Period (months); Initial Periodic Payment Cap; Subsequent Periodic Payment Cap; Initial Minimum Payment Reset Period (months); Subsequent Minimum Payment Reset Period (months); Prepayment Penalty Indicator (for example, 0=No, 1=Yes); Prepayment Penalty Type (for example, Hard—the prepayment penalty is incurred regardless of the reason the loan is prepaid in full; Soft—the prepayment penalty is incurred only if the loan is prepaid in full to a refinancing; Hybrid—the prepayment penalty can be characterized as hard for certain amount of time and soft during another) and Prepayment Penalty Term (months).

Examples of the Product Type referred to above may include 5 Yr Fixed, 60 months; 10 Yr Fixed, 120 months; 15 Yr Fixed, 180 months; 20 Yr Fixed, 240 months; 25 Yr Fixed, 300 months; 30 Yr Fixed, 360 months; 35 Yr Fixed, 420 months; 40 Yr Fixed, 480 months; 1 Mth Arm, 360 months; 1 Yr Arm, 360 months; 2/1 Arm, 360 months; 2/6 Arm, 360 months; 2/28 Yr Arm, 360 months; 2/38 Yr Arm, 480 months; 3/1 Arm, 360 months; 3/6 Arm, 360 months; 3/27 Yr Arm, 360 months; 3/37 Yr Arm, 480 months; 5/1 Arm, 360 months; 5/6 Arm, 360 months; 5/25 Yr Arm, 360 months; 5/35 Yr Arm, 480 months; 6 Mth Arm, 360 months; 7/1 Arm, 360 months; 7/6 Arm, 360 months; 10/1 Arm, 360 months; 10/6 Arm, 360 months; 10/20 Yr Arm, 240 months; 2/28 Balloon, 360 months; 3 year balloon, 360 months; 3/27 Balloon, 360 months; 5 Yr Balloon, 360 months; 5/25 Balloon, 360 months; 7 Yr Balloon, 360 months; 30/15 Yr Balloon, 360 months; 40/30 Yr Balloon, 480 months; 50/30 Balloon, 600 months; HELOC, 360 months; 9 month interest only construction, 9 months; 75/15/10, 360 months; 75/20/5, 360 months; 80/10/10, 360 months; 80/15/5, 360 months.

Examples of the Mortgage Company referred to above may include General Electric Mortgage Insurance Corporation/Genworth Mortgage Insurance Corporation; Mortgage Guaranty Insurance Corporation (MGIC); PMI Mortgage Insurance Company; United Guaranty Residential Insurance Company/United Guaranty Mortgage Indemnity Company; Republic Mortgage Insurance Company (RMIC); Maryland Housing Fund, only for seasoned mortgages insured before Oct. 1, 1999; Commonwealth Mortgage Assurance Company, only for seasoned mortgages insured before Sep. 1, 2009; Triad Guaranty Insurance Corporation (TRIAD); NYC Rehabilitation Mortgage Insurance Corporation (REMIC); California Housing Loan Insurance Fund; Radian Guaranty Inc. only for mortgages insured on or after Sep. 1, 1999 or Amerin Guaranty Corporation, only for seasoned mortgages insured before Sep. 1, 1999; Puerto Rico Housing Finance Authority; Massachusetts Housing Loan Loss Reserve Fund; CMG Mortgage Insurance Company; State of New York Mortgage Agency (SONYMA); Investor Purchased Mortgage Insurance Coverage Option; No Mortgage Insurer—Lender has at least a 10% participation in the mortgage; No Mortgage Insurer—The loan does not exceed 80% of the real property plus the pledged assets; No Mortgage Insurer—Lender repurchases defaulted mortgage under the terms of a repurchase agreement; No Primary Mortgage Insurance Coverage—Mortgage Insurance Pool Coverage Only; No MI required because the loan-to-value ratio (using delivery date UPB and origination date value) is 80% or less; No MI required because the loan-to-value ratio (using delivery date UPB and value determined after origination) is 80% or less; No Mortgage Insurer—mortgage was funded as part of our property disposition or loss mitigation efforts; Mortgage Insurer Code Not Supplied by Lender.

There may be other data elements that may be optional for the Full Analytics Service, but may be needed to perform certain analytics and display certain information on reports such as those described above and shown in Appendices A and B of Provisional Application No. 61/467,747, which are incorporated herein by reference in their entirety. Such optional data elements may include all of the data elements that are optional for the Credit, Income, and Collateral Service, plus Origination Source (for example, Broker, Correspondent, Retail, Wholesale, Other); Loan Officer Name; Underwriter; and Branch.

Although specific examples of data elements have been provided above, other data elements may be used, and the data elements may have different names than the names provided above.

In block 1010, the subroutine 1000 selects an import type in response to an instruction from the user, for example, Insert New Loans Only; Insert New Loans and Update Existing Loans; Update Existing Loans Only; or Delete All Existing Loans and Insert New Loans. If new loans are being imported, the loan data file may have many data elements, such as the data elements for one of the services described above. If existing loans are being updated, the loan data file may have only the data elements that are being updated. For example, the loan data file may have only the FICO score if that is the only data element being updated.

In block 1015, the subroutine 1000 selects a data mapping template in response to an instruction from the user. The data mapping template maps each data element in the uploaded loan data file to one of the data elements that is used in the LoanHD system 800, which will be referred to as LoanHD data elements. The LoanHD data elements may be the data elements that are described above. The purpose of the data mapping template is to allow the user to arrange the data elements in the user's loan data file in any order that is convenient for the user, and to use any names for the data elements that are convenient for the user. The data mapping template is then used to map the data elements in the user's loan data file to the LoanHD data elements that are used in the Loan HD system 800.

In block 1020, the subroutine 1000 determines whether the user has selected an existing data mapping template in response to an instruction from the user. If yes, the subroutine 1000 proceeds to block 1045, where the subroutine 1000 applies the data mappings specified in the data mapping template to the loan data in the uploaded loan data file.

Otherwise, the subroutine 1000 proceeds to block 1025, where the subroutine 1000 names a new data mapping template in response to an instruction from the user.

In block 1030, the subroutine 1000 displays the data elements in the uploaded loan data file.

In block 1035, the subroutine 1000 maps each data element in the uploaded loan data file to one of the LoanHD data elements in response to an instruction from the user. For example, the uploaded loan data file may include a data element “Loan Type” that corresponds to a LoanHD data element “Product Type.” The subroutine 1000 may display a drop-down list of the names of all of the LoanHD data elements by each of the displayed data elements of the uploaded loan data file so the user can select the name of the LoanHD data element to which the data element in the uploaded loan data file is to be mapped. The drop-down list may also include a selection “IGNORE” that the user can select if the user wants to ignore a particular data element in the uploaded loan data file. However, as will be apparent to one of ordinary skill in the art, other techniques may be used to enable the user to perform the data mapping.

In block 1040, in response to an instruction from the user, the subroutine 1000 creates and saves the new data mapping template containing the data mappings specified by the user in block 1035 with the name specified by the user in block 1025.

In block 1045, the subroutine 1000 applies the data mappings to the loan data in the uploaded loan data file in response to an instruction from the user.

In block 1050, the subroutine 1000 displays the mapped loan data elements.

In block 1055, the subroutine 1000 maps values found in text-based data elements in the uploaded loan data file to LoanHD values in response to an instruction from the user. For example, a value of “3 YR Adjustable” in the “Loan Type” data element in the uploaded loan data file might correspond to a LoanHD value of “3/1 ARM” in the LoanHD “Product Type” data element. This mapping step makes it easier for the user to import the user's existing loan data without first having to modify the existing loan data to provide the values expected by the LoanHD system 800.

In block 1060, the subroutine 1000 loads the mapped loan data into a loan queue or updates existing loans in accordance with the selected import type in response to an instruction from the user. The loan queue is a holding place for loans that have not yet been assigned to a loan pool. If the selected import type is Insert New Loans Only, the subroutine 1000 only loads mapped loan data for new loans into the loan queue. If the selected import type is Insert New Loans and Update Existing Loans, the subroutine 1000 loads mapped loan data for new loans into the loan queue, and also updates existing loans with mapped data for existing loans. The existing loans may be in the loan queue if they have not yet been assigned to a loan pool, or may be in a loan pool if they have already been assigned to a loan pool. If the selected import type is Update Existing Loans Only, the subroutine 1000 only updates existing loans with mapped data for existing loans. If the selected import type is Delete All Existing Loans and Insert New Loans, the subroutine 1000 deletes all existing loans in the loan queue and uploads mapped data for new loans into the loan queue. The subroutine 1000 ends in block 1099.

FIG. 11 illustrates an example of the address correction subroutine 1100 shown in FIG. 9. In block 1105, the subroutine 1100 selects loans in the loan queue for which address correction is to be performed in response to an instruction from the user.

In block 1110, the subroutine 1100 selects the type of address to be corrected, i.e., for example, a property address, a borrower mailing address, or a co-borrower mailing address (if any), and whether the address correction is to be run only for new loans of the selected loans, or for all of the selected loans, in response to an instruction from the user.

Correcting the property address ensures that the right property is associated with the loan, and makes it possible to obtain more accurate information about the property, such as value and liens. Correcting the borrower mailing address and the co-borrower mailing address makes it possible to obtain more accurate information about the borrower and the co-borrower, such as creditworthiness. However, other addresses may also be selected for correction.

The subroutine 1100 may enable the user to select the type of address by displaying a list of all types of addresses that can be corrected, with a button by each type of address to enable the user to select that type of address. The subroutine 1100 may display two buttons by each type of address, one button to run the address correction for addresses of that type for only new loans of the selected loans, and another button to run the address correction for addresses of that type for all of the selected loans. However, as will be apparent to one of ordinary skill in the art, other methods of enabling the user to select the address type and whether the address correction is to be run only for new loans or for all selected loans may be used.

In block 1115, the subroutine 1100 initializes a “hit count” variable to be equal to a total number of new loans or selected loans that are to be processed by the subroutine 1100 depending on whether the user selected “run new” or “run all” in block 1110.

Beginning in opening loop block 1120, the subroutine 1100 performs address correction for the selected address type for each of the new loans or each of the selected loans in accordance with the selection made by the user in the block 1110.

In block 1125, the subroutine 1100 determines whether the current selected loan is a new loan, or whether the user selected “run all” in block 1110. If both answers are no, the subroutine 1100 proceeds to closing loop block 1150.

Otherwise, in block 1130, the subroutine 1100 obtains standardized address information including spellings, abbreviations, city names, and ZIP+4 codes according to U.S. Postal Service guidelines for the selected address type for the current selected loan. For example, the subroutine 1100 may obtain the standardized address information by submitting the address information for the selected address type for the current selected loan an address correction vendor in a format required by the vendor and using a submission method required by the vendor, or by using address correction software provided by the vendor. The vendor will typically obtain the standardized address information from an address database provided by the U.S. Postal Service.

In block 1135, the subroutine 1100 determines whether standardized address information was found for the selected address type for the current selected loan. If no, the subroutine 1100 proceeds to block 1140, where the subroutine 1100 highlights the address information for the selected address type in the loan data for the current selected loan in gray, and decrements the “hit count” by one to indicate that standardized information for the selected address type for the current selected loan was not found, and then proceeds to closing loop block 1150. However, any desired color may be used.

Otherwise, in block 1145, the subroutine 1100 stores the standardized address information for the selected address type in the loan data for the current selected loan in the loan queue, replacing the original address information that was loaded into the loan queue.

In closing loop block 1150, the subroutine 1100 iterates back to opening loop block 1120 to process the selected address type for the next new or selected loan if there is one, and if not, proceeds to block 1155.

In block 1155, the subroutine 1100 calculates a “hit rate” for the new or selected loans that have been processed by the address correction indicating a percentage of the selected loans for which standardized address information was found for the selected address type. At that point, the “hit count” is equal to the number of new or selected loans for which standardized address information for the selected address type was found. Therefore, the “hit rate” percentage may be calculated by dividing the “hit count” by the total number of new or selected loans and multiplying the result by 100.

In block 1160, in response to an instruction from the user, the subroutine 1100 generates an error report listing all of the new or selected loans for which standardized address information for the selected address type was not found with the relevant address data elements highlighted in gray, for example, or otherwise marked so the user can scroll through the error report to see which addresses need to be manually corrected in block 930 in FIG. 9.

In block 1199, the subroutine 1100 ends.

FIG. 12 illustrates an example of the data quality report subroutine 1200 shown in FIG. 9. In block 1205, the subroutine 1200 selects loans in the loan queue for which a data quality report is to be generated in response to an instruction from the user.

In block 1210, the subroutine 1200 selects the type of service for which a data quality report is to be generated, such as one of the Credit and Income Service; the Credit, Income, and Collateral Service; and the Full Analytics Service discussed above, or selects one or more of the vendors, such as the Credit Information Service, AVM Service 1, AVM Service 2, AVM Service 3, Financial Profile Information Service, Predictive Analytics Service 1, Predictive Analytics Service 2, Loan Eligibility and Pricing Service, and Lien Information Service vendors described above, in response to an instruction from the user. The subroutine 1200 may enable the user to select the type of service or one or more vendors by displaying a pop-up window with a pre-defined report section listing all types of services that are available with a radio button by each type of service to enable the user to select that type of service, a custom report section listing all vendors that are available with a checkbox by each vendor to enable the user to select that vendor, and a Create Report button that when clicked runs the data quality report subroutine 1200 in FIG. 12 and displays the data quality report that is generated in block 1275 in FIG. 12. The subroutine 1200 may enable only one type of service to be selected at a time, may enable two or more vendors to be selected at a time, and may deselect any selected type of service if a vendor is selected. However, as will be apparent to one of ordinary skill in the art, other methods of enabling the user to select the type of service or one or more vendors may be used.

In block 1215, the subroutine 1200 initializes a “hit count” variable for each data element associated with the selected type of service or the selected vendor or vendors to be equal to a total number of selected loans that are to be processed by the subroutine 1200.

Beginning in opening loop block 1220, the subroutine 1200 generates a data quality report for the selected loans.

Beginning in opening loop block 1225, the subroutine 1200 generates a data quality report for the data elements associated with the selected type of service or the selected vendor or vendors.

In block 1230, the subroutine 1200 determines whether the current data element is missing or invalid. The subroutine 1200 may determine whether the current data element is missing by determining whether the data field for the current data element is empty. The subroutine may determine whether the current data element is invalid by checking the format and value of the current data element against a database of all of the LoanHD data elements listing the required format and permissible values or range of values for each data element. However, as will be apparent to one of ordinary skill in the art, other methods of determining whether the current data element is missing or invalid may be used.

If the subroutine 1200 determines in block 1230 that the current data element is not missing and is not invalid, the subroutine 1200 proceeds to closing loop block 1260.

If the subroutine 1200 determines in block 1230 that the current data element is missing or invalid, the subroutine proceeds to block 1235, where the subroutine 1200 determines whether the current data element being missing or invalid results in a fatal error, a warning, an address error, or an analytic error. A fatal error indicates that the missing or invalid data element will make it impossible to run one or more loan-data vendor services. A warning indicates that the missing or invalid data element is necessary to obtain vendor loan data from a loan-data vendor but is not a fatal error. An address error indicates missing address information. An analytic error indicates that the missing or invalid data element is necessary to display certain charts, graphs, data tables, data analyses, trends, or other analytics in one or more reports to be described later. The subroutine 1200 may determine whether the error is fatal error or a warning by referring to a database that lists all of LoanHD data elements, and for each data element, the loan-vendor services that require that data element and the analytics and reports that require that data element. The subroutine 1200 may determine whether the error is an address error by determining whether the current data element is an address data element that is missing. The subroutine 1200 may determine whether the error is an analytic error by referring to a database that lists all of LoanHD data elements that are required to display all of the charts, graphs, data tables, data analyses, trends, and other analytics in all of the reports that can be generated by the LoanHD system.

If the subroutine 1200 determines in block 1235 that the error is a fatal error, the subroutine 1200 proceeds to block 1240, where the subroutine 1200 highlights the current data element in the loan data for the current selected loan in red to indicate a fatal error, and then proceeds to block 1260. However, any desired color may be used.

If the subroutine 1200 determines in block 1235 that the error is a warning, the subroutine 1200 proceeds to block 1245, where the subroutine 1200 highlights the current data element in the loan data for the current selected loan in yellow to indicate a warning, and then proceeds to block 1260. However, any desired color may be used.

If the subroutine 1200 determines in block 1235 that the error is an address error, the subroutine 1200 proceeds to block 1250, where the subroutine 1200 highlights the current data element in the loan data for the current selected loan in gray to indicate an address error, i.e., missing address information, and then proceeds to block 1260. However, any desired color may be used.

If the subroutine 1200 determines in block 1235 that the error is an analytic error, the subroutine proceeds to block 1255, where the subroutine 1200 highlights the current data element in the loan data for the current selected loan in blue to indicate an analytic error, and then proceeds to block 1260. However, any desired color may be used.

In block 1260, the subroutine 1200 decrements the “hit count” for the current data element by one to indicate that the current data element is missing or invalid, and then proceeds to closing loop block 1265.

In closing loop block 1265, the subroutine 1200 iterates back to opening loop block 1225 to process the next data element for the current selected loan if there is one, and if not, proceeds to closing loop block 1270.

In closing loop block 1270, the subroutine 1200 iterates back to opening loop block 1220 to process the next selected loan if there is one, and if not, proceeds to block 1275.

In block 1275, the subroutine 1200 generates a data quality report that lists the total number of loans that were processed, and the data elements that were processed. For each of the data elements, the data quality report lists the total number of loans in which the data element was present and valid (equal to the hit rate for that data element); the total number of loans for which the data element was missing or invalid (equal to the total number of loans minus the hit rate for that data element); a red stop sign icon if there is a fatal error for that data element in any of the loans; a yellow upward pointing triangle icon with an exclamation point in it if there is a warning for that data element in any of the loans; a chart icon representing a graph or chart if there is an analytic error for that data element in any of the loans; a link to open a journal entry ticket to log a new journal entry or data ticket; a link to display any existing journal entry or data assumption; and the last journal entry. However, the data quality report may omit some of these items, and/or may include additional or different items. Also, any desired colors may be used for the stop sign icon and the upward pointing triangle icon instead of red and yellow, any other icons may be used instead of the stop sign icon, the upward pointing triangle icon with an exclamation point in it, and the chart icon. If the user clinks on the link to display any existing journal entry or data assumption that was logged in block 965 in FIG. 9, links to edit and delete the existing journal entry or data assumption may be displayed.

In block 1299, the subroutine 1200 ends.

FIG. 13 illustrates an example of a loan/pool managing and analyzing routine 1300 that is performed by the loan/pool managing and analyzing engine 830 in FIG. 8.

In block 1310, the routine 1300 displays the loans in the loan queue. The loans may be displayed in a list, with one loan in each row and various loan data being displayed in columns, such as LoanID, Ext. ID, Import Date, Last Modified Date, Property Address Correction Date, Borrower Address Correction Date, Lien Type, Mortgage Type, and Loan Balance. As indicated above, Loan ID is an internal loan identifier assigned to the loan by the LoanHD system, and Ext. ID is the user's loan identifier. However, other data may be displayed. Each column may have a clickable header enabling a user to sort the loans by the data in that column, toggling between sort up and sort down each time the header is clicked. However, the loan data may displayed in other formats.

Edit functions may be displayed for the loans in the loan queue, such as Delete, Run Address Correction, and Run Data Quality Report. The edit functions are performed by selecting loans in the loan queue to be edited, and then clicking on the desired edit function. To enable the user to select loans in the loan queue, a checkbox may be displayed next to each the loans to enable the user to select each loan individually, and a checkbox may be displayed at the top of the list to enable the user to select all of the loans simultaneously. However, as will be apparent to one of ordinary skill in the art, other methods of enabling the user to select loans in the loan queue may be used.

In block 1320, the routine 1300 selects loans in the loan queue in response to an instruction from the user.

In block 1330, the routine 1300 deletes the selected loans if the user selects the Delete edit function.

In block 1340, the routine 1300 runs the address correction subroutine 1100 in FIG. 11 for the selected loans if the user selects the Run Address Correction edit function.

In block 1350, the routine 1300 runs the data quality report subroutine 1200 in FIG. 12 for the selected loans if the user selects the Run Data Quality Report edit function. The user may be prevented from assigning any of the loans in the loan queue to a loan pool until the user has selected the Run Data Quality Report edit function.

In block 1360, the routine 1300 selects between assigning only selected loans without fatal errors to a loan pool, and assigning all selected loans regardless of fatal errors to a loan pool, in response to an instruction from the user. The subroutine 1300 may enable the user to make this selection by displaying two buttons, one labeled Import Only Loans Without Fatal Errors enabling the user to assign only selected loans without fatal errors to a loan pool, and the other one labeled Import All Loans enabling the user to assign all selected loans regardless of fatal errors to a loan pool. However, as will be apparent to one of ordinary skill in the art, other methods of enabling the user to make the selection may be used.

In block 1370, the routine 1300 assigns only the selected loans without fatal errors to a new loan pool in response to an instruction from the user and a new loan pool name provided by the user, or to an existing loan pool in response to an instruction from the user and an existing loan pool name selected by the user from, for example, a drop-down list of existing loan pool names, and removes the selected loans without fatal errors from the loan queue. However, as will be apparent to one of ordinary skill in the art, other methods of enabling the user to select an existing loan pool name may be used.

In block 1380, the routine 1300 assigns all of the selected loans to a new loan pool in response to an instruction from the user and a new loan pool name provided by the user, or to an existing loan pool in response to an instruction from the user and an existing loan pool name selected by the user from, for example, a drop-down list of existing loan pool names, and removes all of the selected loans from the loan queue. However, as will be apparent to one of ordinary skill in the art, other methods of enabling the user to select an existing loan pool name may be used.

In block 1399, the subroutine 1300 ends.

FIG. 14 illustrates an example of a loan/pool managing and analyzing routine 1400 that is performed by the loan/pool managing and analyzing engine 830 in FIG. 8. In block 1405, the routine 1400 displays a portfolio page with loan pool statistics and a list of the loan pools. For example, the list of loan pools may have one loan pool in each row and columns labeled, for example, Pool Name, Loan Category, Summary, Analytics, Refresh Information (including Schedule Refresh, Active, Next Run Date), Edit, and Delete.

The loan pool statistics may include a summary for the entire portfolio of loans displayed in a band near the top of the portfolio page highlighted, for example, in yellow and listing, for example, a total number of loans in the loan pools and a total loan balance of the loans in the loan pool for categories of aggregate, secured, and unsecured, with aggregate being a total of the secured loans and the unsecured loans. However, the loan portfolio summary is not limited to this information, and some of this information may be omitted and/or other information may be displayed.

The loan pool statistics may include totals for different categories of loans in the loan pools, such as total mortgage, first mortgage, second mortgage, HELOC (home-equity line of credit), automobile, credit cards, student loans, and personal & other. However, as will be apparent to one of ordinary skill in the art, other categories of loans may be listed.

The loan pool statistics for the mortgages and HELOCs may include total number of loans, total balance, WA (weighted average) coupon, WA FICO, WA LTV (loan to value), WA seasoning, and WA maturity. Statistics for the automobile and student loans may include total number of loans, total balance, WA coupon, WA FICO, WA seasoning, and WA maturity. Statistics for the credit cards and personal & other loans may include total number of loans, total balance, WA coupon, and WA FICO. However, as will be apparent to one of ordinary skill in the art, other statistics may be listed.

The columns of the loan pool list labeled Summary, Analytics, Edit, and Delete contain LinkButtons for each loan pool enabling a user to select one of the loan pools and perform a function.

The LinkButtons in the Summary column may be labeled View. The LinkButtons in the Analytics column may be labeled Analytics. The Schedule Refresh column may list Credit & Income; Credit, Income & Collateral; or Full Analytics depending on the last type of service selected by the user. The Active column may list Yes or No depending on the last selection made by the user. The Next Run Date column may list the next date the service is to be run or may be blank if a refresh has never been scheduled. The LinkButtons in the Edit column may be labeled Edit. The LinkButtons in the Delete column may be labeled Delete.

In block 1410, the routine 1400 selects a loan pool and a function to be performed in response to an instruction from the user.

In block 1415, the routine 1400 performs the View function in response to an instruction from the user. The View function displays loan pool statistics for the selected loan pool in a pop-up window listing, for example, the name of the selected loan pool, the total number of loans in the selected loan pool, the total balance of the loans in the selected loan pool, the last refresh date, and the next refresh date. The loan pool statistics may also include additional loan pool statistics appropriate for the type of loan. For example, if the loans in the selected loan pool are mortgages, the additional loan pool statistics may include WA coupon, WA FICO, WA LTV, WA seasoning, and WA maturity.

In block 1420, the routine 1400 returns to block 1410 to enable the user to select another loan pool and/or another function.

In block 1425, the routine 1400 initiates the Analytics function for the selected loan pool in response to an instruction from the user. The Analytics function generates the multi-vendor pool-level reports that are generated by the subroutine 500 in FIG. 5 and are shown in Appendix A of Provisional Application No. 61/467,747, which is incorporated herein by reference in its entirety. These reports may also be called pages or views.

In block 1430, the routine 1400 displays any of the available reports in response to an instruction from the user. The routine 1400 may do this by displaying a page including tabs that the user can click on to select various categories of reports. The tabs may be labeled Risk Card, Statistics, Credit, Income, Collateral, Liens, Risk Models, Valuation, and Activity. Each tab may have a plurality of LinkButtons that the user can use to select a specific report within the category.

The Risk Card tab displays a Risk Card, which lists a plurality of metrics for the loan pool, with one metric per line, the latest value of each metric, the percentage change in the metric since origination, a gauge indicating a trend in the metric, and a risk gauge for each metric. The hit rate is the percentage of loans in the loan pool for which the loan-data vendor was able to provide the metric. While in this example the Risk Card is displayed for a loan pool, the Risk Card may also be displayed for a single loan, or for a plurality of pools of loans.

The gauge indicating a trend in the metric is a graphical indicator. For example, the gauge may be an upward or downward pointing triangle to indicate a change in the metric, with the triangle being colored green if the change is in a desirable direction, such as an increase in the FICO score, and being colored red if the trend is in an undesirable direction, such as a decrease in the FICO score. The gauge may be a black horizontal line if there was no change in the metric. However, other symbols and other colors may be used as the gauges.

The risk gauge of each metric is divided into three sections containing the words LOW, MODERATE, and HIGH to indicate low, moderate, and high risk. The heading of the list of metrics in the Risk Card also contains three sections containing the words LOW, MODERATE, and HIGH. The LOW section in the heading is highlighted in blue; the MODERATE section in the heading is highlighted in yellow, and the HIGH section in the heading is highlighted in red. A range of metric values is assigned to each section. For example, for the FICO Score metric, a range of 660 and above may be assigned to the LOW section, a range of 620-659 may be assigned to the MODERATE section, and a range of 619 and below may be assigned to the HIGH section. When the Risk Card is displayed, if a metric falls into the range of values set for the LOW section, the LOW section for that metric is highlighted in blue. If the metric falls into the range of values set for the MODERATE section, the MODERATE section for that metric is highlighted in yellow. If the metric falls into the range of values set for the HIGH section, the HIGH section for that metric is highlighted in red. If the hit ratio for any metric is 0%, none of the sections for that metric are highlighted. However, other color schemes and other ways of indicating current risk level for metrics may be used.

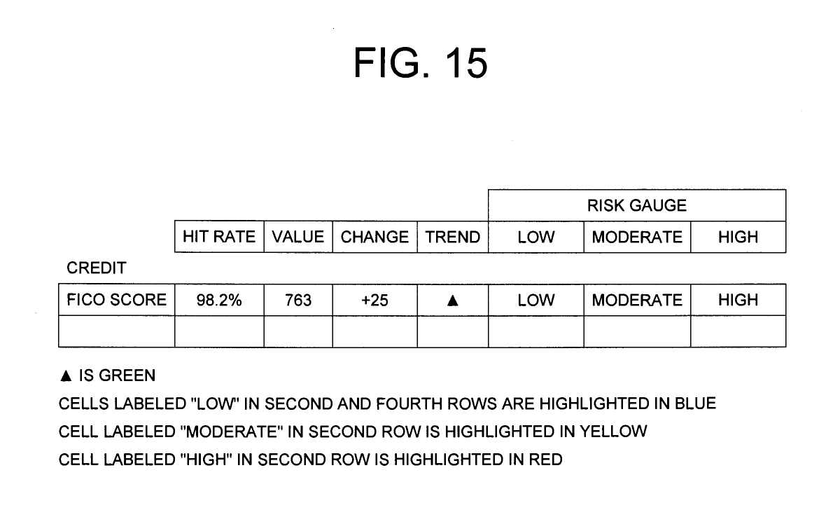

FIG. 15 illustrates an example of a portion of a Risk Card listing the FICO Score metric. Since the FICO Score has increased by 25 points, the gauge in the Trend column is a green upward pointing triangle. Since the FICO Score is 763, which is in the range of greater 660 and above assigned to the LOW section, the LOW section for the FICO Score metric is highlighted in blue.

A loan pool summary for the loan pool may be displayed in a band near the top of the Risk Card highlighted, for example, in yellow and listing, for example, a total number of loans in the loan pool, the last refresh date, the total balance of the loans in the loan pool, WA coupon, WA FICO, WA LTV, WA seasoning, WA maturity, lien type, performance, and amortization if the loans in the loan pool are mortgages. However, the loan pool summary is not limited to this information, and some of this information may be omitted and/or other information may be displayed.

Various templates for the Risk Card may be provided. Examples of such templates include Default, Examination, Review—Internal, Mortgage Risk Matrix, and Consumer Risk Matrix. The various templates make it easy to generate Risk Cards displaying different sets of metrics based on different risk parameters that are specifically tailored to particular audiences. For example, one Risk card with the minimum number of metrics that are legally required might be prepared for use by a government auditor, and another Risk Card listing all of the metrics that are available might be prepared for use by the Chief Risk Office of a company.

A new Risk Card template may be created or an existing Risk Card template may be edited by instructing the LoanHD engine to display a Risk Card settings page, which may display a drop-down box to select the default template to create a new Risk Card template, or to select an existing Risk Card template to edit. A new Risk Card template will automatically be set to system default values.

The Risk Card settings page may have tabs for categories Credit, Income, Collateral, Liens, and Risk Models, but some of these categories may be omitted and other categories may be added.

Selecting the Credit category tab will display a list of Credit metrics that may include, for example, Credit Scores & Models including FICO Score, FICO Non-Prime Credit Ratio, Risk of Delinquency 60+ Rate, Risk of Delinquency 90+ Rate, Risk of Delinquency CO+ Rate, Risk of Delinquency BK+ Rate, VantageScore, VantageScore Non-Prime Credit Ratio, Bankruptcy Score, Risk of Delinquency 60+ Rate, Risk of Delinquency 90+ Rate, Risk of Delinquency CO+Rate, and Risk of Delinquency BK+ Rate; Credit Utilizations including Total Credit, Mortgage Credit, Bankcard Credit, Revolving Credit, Installment Credit, Retail Credit, Finance Credit, and HELOC; Payment Activity including Mortgage Payment—Current, Mortgage Payment—30-59 Days, Mortgage Payment—60-89 Days, Mortgage Payment—90+ Days, Mortgage, Active Trades 30 Days, Active Trades 60 Days, and Active Trades 90 Days; Credit Gauges including Liability Meter, Increasing Liability Ratio, and Mortgage Debt Meter; Quest for Credit including Inquires in Last 6 Months, and Tradelines Opened in Last 12 Months.

Selecting the Income category tab will display a list of Income metrics that may include, for example, Ability to Pay Index and Income360.

Selecting the Collateral category tab will display a list of Collateral metrics that may include, for example, WA LTV, LTV, CLTV, HELOC HCLTV, Accuracy of Valuation (Confidence Score), Market/Fraud Risk (Collateral Integrity), Value Validation, Value Validation—Accept, Value Validation—Review, Value Validation—Unable to Reconcile, Negative Equity, Negative Equity Ratio, and Value Forecast.

Selecting the Liens category tab will display a list of Liens metrics that may include, for example, Silent Lien Ratio, Silent Liens, Credit Report Discrepancy, Filing/Recording Discrepancy, Lien Address Discrepancy, and Own Other Property.

Selecting the Risk Models category will display a list of Risk Models metrics that may include, for example, Delinquency, Predictive Analytics Service 2 Risk Grade, Predictive Analytics Service 2 Foreclosure Frequency, Predictive Analytics Service 1 Cumulative Default, Predictive Analytics Service 1 Prepayment, Predictive Analytics Service 2 Loss Severity, Predictive Analytics Service 1 Loss Severity, Predictive Analytics Service 2 Loss Coverage (Risk Ratio), and Predictive Analytics Service 1 Cumulative Loss.

Each line of the list of metrics includes the name of a metric; an activate field that includes a loan checkbox and/or a pool checkbox; risk gauge settings including lower and upper limit data fields for each of the LOW, MODERATE, and HIGH sections of the risk gauge; and a use defaults checkbox.

Checking the loan checkbox for a metric will display that metric on a loan-level Risk Card. Checking the pool checkbox for a metric will display that metric on a pool-level Risk Card. Checking both the loan checkbox and the pool checkbox for a metric will display that metric on both a loan-level Risk Card and a pool-level Risk Card. Some metrics have only a loan checkbox because they are not applicable to a loan pool. Some metrics have only a pool checkbox because they are not applicable to a single loan.

The lower and upper limit data fields are used to enter desired lower and upper limits for each of the LOW, MODERATE, and HIGH sections of the risk gauge for each metric. Some metrics may require only an upper limit or only a lower limit. For example, for the FICO Score metric, when scores of 619 and below are considered to be high risk, only the upper limit of 619 need be entered into the upper limit data field for the HIGH section of the Risk Gauge.

The use defaults checkbox can be checked to use system default settings for the loan checkbox, the pool checkbox, and the upper and lower limit data fields.

The Risk Card enables the user to get a quick idea of the overall risk on a loan pool or a specific loan by presenting evaluations of the risks for metrics in one simple easy-to-read report, making it unnecessary for the user to review as many as 30 or more single-metric reports.

Returning to the other tabs that are displayed when the Analytics function is selected, the Statistics tab may include LinkButtons to display reports for Origination, Product Group, Product Type, Loan Size, Coupon, Occupancy, Documentation, Seasoning, Amortization, and Mortgage Insurance.

The Credit tab may include LinkButtons to display reports for FICO Score, VantageScore, Bankruptcy Score, Risk of Delinquency, Liability Meter, Mortgage Payment, Mortgage Credit, General Credit, and Credit Accounts.

The Income tab may include LinkButtons to display reports for Income, Ability to Pay Index, Income 360, and Income Movement.

The Collateral tab may include LinkButtons to display reports for LTV/CLTV (Loan to Value/Combined Loan to Value), HELOC (home-equity line of credit) Analysis, Value Analysis, Value Forecast, Collateral Integrity, Confidence Analysis, Collateral Validation, Property Type, and Geographic Concentration.

The Liens tab may include LinkButtons to display reports for Silent Liens, Recorded Liens, and Properties.

The Risk Models tab may include LinkButtons to display reports for Summary, Delinquency, Default, Prepayment, Loss Severity, and Cumulative Loss.

Returning to the other tabs that are displayed when the Analytics function is selected, the Valuation tab may include LinkButtons to display reports for Sale/Eligibility and Market Valuation.

The Activity tab may display an Activity report that provides transparent views into high-level borrower and property profiles, vendor hit rates, pool refresh schedules and billing, and so forth.

The reports may have a standardized format in which similar types of information appear at the same places in all of the reports to make it easier for the user to find the information the user is looking for.

For example, a loan pool summary for the loan pool may be displayed in a band near the top of the report page highlighted, for example, in yellow and listing, for example, a total number of loans in the loan pool, the last refresh date, the total balance of the loans in the loan pool, WA coupon, WA FICO, WA LTV, WA seasoning, WA maturity, lien type, performance, and amortization if the loans in the loan pool are mortgages. However, the loan pool summary is not limited to this information, and some of this information may be omitted and/or other information may be displayed.

Under the last refresh date there may be displayed a LinkButton labeled Details that when clicked may display a pop-up window listing the date or dates the loan-data vendor services were last run, and services that were run.

If there is a warning for any of the displayed data, a red LinkButton labeled Warning may be displayed under that data. An example of a warning that might be displayed below the WA FICO data is as follows: WARNING: Because most consumer credit risk scores are non-linear, an average score for a group of consumers may NOT accurately measure the underlying risk of the group. We provide average scores here at the request of our clients, but we recommend against using average scores for evaluating a portfolio or setting strategy. For a more accurate measure of the risk of a population segment or pool of loans, we recommend using the Average Risk of Delinquency measures provided on the Risk of Delinquency page.

The reports may have an analysis section analyzing one or more loan metrics. For example, the FICO Score report in the Credit category may include Average WA FICO, Borrower WA FICO, Co-Borrower WA FICO, Loans Below OFICO Ratio, and Non-Prime Credit shown, for example, as horizontal bar graphs constituting gauges showing where the values fall within the applicable ranges. Buttons may provided above the bar graph section to enable the user to select Borrower, Co-Borrower, and Average. The vendor hit rate for the metric may be displayed between the button section and the bar graph section.

A clickable chart icon representing a graph or chart may be displayed next to each of the bar graphs. Clicking on this chart icon will display a historical graph of the selected metric below the bar graph section. Trend data for all of the metrics may be displayed below the historical graph section. Also displayed next to each of the bar graphs may be the numerical change in the metric from the original value, and a gauge, which is a graphical indicator of a trend in the metric. For example, the gauge may be an upward or downward pointing triangle to indicate a change in the metric, with the triangle being colored green if the change is in a desirable direction, such as an increase in the FICO score, and being colored red if the trend is in an undesirable direction, such as a decrease in the FICO score. The gauge may be a black horizontal line if there was no change in the metric.

A credit classification stratification table may be displayed below the trend data section listing the number of loans, the loan balance, the percentage of the total loan balance, the WA FICO, and the WA LTV for classifications of prime, alt-A, subprime, and no hit. A horizontal bar graph or gauge showing the concentration of each classification may be displayed next to the table. Thus, the credit classification stratification table is paired with a concentration visual gauge, enabling the user to quickly see the concentration risk across the stratification groupings and assess the risk. This pairing of a stratification table with a concentration visual gauge may be used in all of the reports generated by the LoanHD system.

Distribution charts showing the distribution of the FICO score by number of loans and by balance may be displayed below the credit classification stratification table. Buttons may be provide to select refreshed, original, and both.

A FICO stratification table may displayed below the distribution charts with a horizontal bar chart showing the concentration for each score range. Buttons may be provided to select between 60+ rate, 90+ rate, CO+ rate, and BK rate.

A list of the loans in the loan may be displayed below the FICO stratification table listing LoanID, original loan balance, current loan balance, original FICO and weighting, refreshed FIOC and weighting, no hit, and difference, with horizontal bar graphs constituting gauges depicting the original and refreshed FICO scores. However, in other reports, the data that is listed is the specific data that was used to generate that report. A checkbox may be displayed next to each of the loans, and a button labeled Analytics Summary may be provided above the list. By clicking the checkbox for one or more of the loans and clicking the Analytics Summary button, the analytics can be run again without the loans that have been checked so the user can instantly see the effect of removing certain loans from the loan pool.

The Loan IDs in the list of the loans may be displayed as links that the user can point to using a mouse or other pointing device to display a pop-up window listing Loan ID, Ext. ID, borrower name, co-borrower name, and a selection Loan Statement: Open, with a PDF icon by the word Open. The word Open may be a LinkButton that when clicked will display a loan statement for the loan. The loan statement is a multi-vendor loan level report that lists all of the metrics, analyses, and other information that is available for the selected loan, and is generated by the subroutine 600 in FIG. 6. The first page of the loan statement may be a Risk Card for the selected loan, which is similar to the Risk Card for the loan pools discussed above, except that it does not include the hit rate. The loan statement may include a Print Statement button and a PDF Statement button. The Print Statement button will print the loan statement. The PDF Statement button will convert the loan statement to a PDF loan statement that may be saved or printed. A PDF icon may be displayed next to the Loan ID for each of the loans in the list. Clicking on the PDF icon will generate the PDF loan statement directly without having to first display the loan statement and then convert the loan statement to a PDF loan statement. However, as will be apparent to one of ordinary skill in the art, other techniques may be used to enable the user to display the loan statement, print the loan statement, and generate the PDF loan statement. The loan statement is similar to the loan-level report in Appendix B of Provisional Application No. 61/467,747, which is incorporated herein by reference in its entirety, except that the loan-level report in Appendix B does not include a Risk Card.

A button labeled Analytics Summary may be provided above the list of the loans with the message “You can view the result of removing a loan(s) by selecting the loan(s) and then click “Analytics Summary.” If one or more loans are selected by clicking the checkbox next to the loans and the Analytics Summary button is clicked, the routine 1400 displays a pop-up Analytics Summary window displaying three loan pools summaries having the same format as the loan pool summary displayed at the top of the report page, one labeled Existing for the all of the loans in the loan pool, one labeled Removed for the loans that were selected, and one labeled New for the remaining loans in the loan pool that were not selected. Under Removed are two LinkButtons, one labeled Mark for Editing and the other labeled Move Loans.

The Mark for Editing button when clicked displays a Mark for Editing pop-up window with a combo box with the instruction “Please select a reason for marking these loans or create a new one by entering the name of the reason,” a Save button, a Cancel button, and an X button to close the Mark for Editing pop-window. The user can enter a reason in the combo box, or use the drop-down portion of the combo box to select a pre-defined reason, such as Test, Investor Loans, or Unknown CLTV. This causes a green check mark to be entered into a Marked for Editing data element for each loan that was selected, and causes the reason entered into the combo box to be entered into a Marked Reason data element for each loan that was selected. Alternatively, the user can click the Cancel button or the X button to close the Mark for Editing pop-up window without marking the selected loans for editing. However, another color may be used instead of green, and another icon may be used instead of the check mark icon.

The Move Loans button when click displays a Move pop-up window with a checkbox labeled Move selected Loan(s) to the Loan Queue, a drop-down box to select the name of an existing loan pool, a Save button, a Cancel button, and an X button to close the pop-up window. The user can move the selected loans to an existing loan pool by selecting the name of an existing loan pool using the drop-down box and clicking the Save button. Alternatively, the user can click the Cancel button or the X button to close the Move pop-up window without moving the selected loans.

A button labeled Download may be provided above the list of the loans. Clicking on the button will download the raw data for the report to a spreadsheet.

The report may also include near the top on the right side an Experts & Resources section listing the loan-data vendor from which the data used to generate the report was obtained. This section may include links to the loan-data vendor's Web site or to relevant information.

Beneath the Experts & Resources section may be a section with collapsible and expandable menus listing Alerts, Data, Benchmarks, and Help. Collapse all and Expand all buttons may be provided to collapse or expand all of the menus simultaneously. Any data assumption that has been applied to the report will appear in the Alerts menu, and may be displayed in red to draw attention to it. Also, any alert that has been assigned to the report and has been triggered will be displayed in the Alerts menu. The alert will be described in detail below in connection the reporting and alerting routine 1800 in FIG. 18. The Data menu may list data relevant to the current metric. For example, for the FICO Score report, the data menu may list Average WA FICO, Borrower WA FICO, Co-Borrower WA FICO, the number of loans and the percentage of the total number of the loans for prime credit, non-prime, and no hit, and standardized credit definitions for the FICO Score. Any data that may indicate a problem may be displayed in red to draw attention to it. The benchmarks menu may list an analysis of the metric or other information relating to the metric. The help menu may list contact information for the vendor and sources of information.

An example of a report for the FICO Score metric has been described above. Of course, the reports for other metrics will include data and analyses relevant to that matrix.

The report that is displayed when the Activity tab is selected may have a somewhat different format. For example, the Analysis section of the report may have Pool Inception, Borrowers, Properties with Multiple Liens, Vendor Hit Rates, Refresh Schedule, Journal Entries, and Historical Vendor Activity sections.

The Pool Inception section may list the date the loan pool was created.

The Borrowers section may list the number of borrowers in the loan pool, the number of co-borrowers in the loan pool, and their sum, which is the total number of borrowers and co-borrowers in the loan pool.

The Properties with Multiple Liens section may list the total number of liens in the loan pool, the number of distinct properties in the loan pool, and their difference, which is the number of properties with multiple liens in the loan pool.

The Vendor Hit Rates section may list the analyses (i.e., the vendor loan data element) that appears on the reports, such as FICO Score—Borrower, FICO Score—Co-Borrower, VantageScore—Borrower, Vantage Score—Co-Borrower, Ability to Pay, Income360, Collateral Values 1, Collateral Values 2, Collateral Values 3, etc. The listing for each analysis may include the vendor that provided the analysis, the last run date of the analysis, a data quality report LinkButton labeled view, the total number of loans in the loan pool on which the analysis was run, the number of loans for which the vendor was able to perform the analysis, i.e., the number of hits, the hit rate in percentage, which is equal to the number of hits divided by the number of loans times 100, and a horizontal bar graph or gauge showing the hit rate.

If the user clicks on the data quality report LinkButton labeled view for one of the analyses (i.e., one of the vendor loan data elements), the user can run the data quality report subroutine 1200 in FIG. 12 for that analysis or vendor loan data element and display the data quality report that is generated in block 1275 in FIG. 12. This enables to the user to determine why the vendor was not able to provide the analysis or vendor loan data element for all of the loans in the loan pool. The routine may enable the user to correct the errors identified in the data quality report using the loan edit function described in detail above in connection with blocks 930 and 955 in FIG. 9 to increase the hit rate the next time the analysis or vendor loan data element is refreshed.

If the user clicks on the data quality report LinkButton labeled view for one of the analyses (i.e., one of the vendor loan data elements), the routine 1400 may also enable the user to run the data quality report subroutine 1200 in FIG. 12 for a selected type of service, such as one of the Credit and Income Service; the Credit, Income, and Collateral Service; and the Full Analytics Service discussed above, or for one or more selected vendors, such as the Credit Information Service, AVM Service 1, AVM Service 2, AVM Service 3, Financial Profile Information Service, Predictive Analytics Service 1, Predictive Analytics Service 2, Loan Eligibility and Pricing Service, and Lien Information Service vendors described above. The routine 1400 may enable the user to select the type of service or one or more vendors by displaying a pop-up window with a pre-defined report section listing all types of services that are available with a radio button by each type of service to enable the user to select that type of service, a custom report section listing all vendors that are available with a checkbox by each vendor to enable the user to select that vendor, and a Create Report button that when clicked runs the data quality report subroutine 1200 in FIG. 12 and displays the data quality report that is generated in block 1275 in FIG. 12. The routine 1400 may enable only one type of service to be selected at a time, may enable two or more vendors to be selected at a time, and may deselect any selected type of service if a vendor is selected. However, as will be apparent to one of ordinary skill in the art, other methods of enabling the user to select the type of service or one or more vendors may be used.

The Refresh Schedule may list the schedule refresh dates over the next two years or other suitable period of time.

The Journal Entries section may have buttons labeled Journal Entries and Data Assumptions. When the Journal Entries button is clicked, the report may list the journal entries for the loan pool. The listing for each journal entry may include the loan number, the date of the journal entry, the issue owner, the data element, the issue, the resolved date, and a button to open or save a spreadsheet file listing the journal entry data. The routine 1400 may enable the user to edit, delete, or add journal entries using the same procedures described above in connection with block 965 in FIG. 9.

When the Data Assumptions button is clicked, the report may list the data assumptions for the loan pool. The listing for each data assumption may include the loan number, the date of the data assumption, who entered the data assumption, who approved the data assumption, the data element, the data assumption, and a button to open or save a spreadsheet listing the data assumption data. The routine 1400 may enable the user to edit, delete, or add data assumptions using the same procedures described above in connection with block 965 in FIG. 9.

The Historical Vendor Activity section may display a From date text box with a pop-up calendar, a To date text box with a pop-up calendar, and a Run Report button. The user can enter a From date and a To date, and then press the Run Report button to display a vendor activity list of all vendor activity in the period between the two dates. The listing for each vendor activity in the vendor activity list may include the vendor, the service that was run, the name of the loan pool for which the service was run, the total number of loans for which the service was run, the start date, the complete date, the turn time in hours, the number of hits, and the hit rate, which is the number of hits divided by the number of loans times 100.

The Activity report may also include a Experts & Resources section as do the other reports. The Experts & Resources report may list the vendors who provided data for the analyses.

In block 1435, the routine 1400 returns to block 1410 to enable the user to select another loan pool and/or another function.

In block 1440, the routine 1400 performs the Schedule Refresh function in response to an instruction from the user if the user has been granted the authority to schedule refreshes, or an instruction from a LoanHD administrator if he user has not been granted the authority to schedule refreshes. The Schedule Refresh function enables the user or the LoanHD administrator to select the type of service to be performed, such as Credit & Income; Credit, Income & Collateral; or Full Analytics; mark the service as being active (Yes) or inactive (No), and set the date of the next refresh. Although the Schedule Refresh function is shown as being part of the loan/pool managing and analyzing routine 1400, the Schedule Refresh function may be provided as a separate routine by the LoanHD system.

The Schedule Refresh function may be accessed by clicking on a Pools tab displayed by the Loan HD system. Clicking on the Pools tab displays a Pools page listing all of the loan pools in the user's portfolio, with one loan pool in each row and columns labeled Pool ID, Pool Name, Schedule Refresh, Active, Next Run Date, and Display columns labeled Risk Card, Statistics, Credit, Income, Collateral, Liens, Risk Models, and Valuation. In the Schedule Refresh column are LinkButtons labeled with the name of the refresh service that is to be run for the pool, i.e., Credit & Income; Credit, Income & Collateral; or Full Analytics.

Clicking on the Schedule Refresh button for one of the pools opens a Refresh tab with a text box with pop-up calendar to enter a start date, a drop-down box to select the refresh service, a drop-down box to select a pricing options, such as annual bundle, a text box to enter a price per loan, a text box to enter a cost for co-borrowers, and a checkbox labeled Is Active that when checked actives the scheduled refresh and when unchecked deactivates the scheduled refresh, and a refresh schedule for the selected refresh service and pricing option that lists each vendor service, the number of annual runs for each vendor service, and the dates each vendor service will be run in the year beginning on the start date. The dates may be displayed in text boxes with pop-up calendars.

Next to the Refresh tab is a Summary tab that when clicked displays the history of all refreshes for the pool, with a Last 30 days section that displays a vendor activity list of all vendor activity during the last 30 days and a Historical section that displays a From date text box with a pop-up calendar, a To date text box with a pop-up calendar, and a Run Report button. The user can enter a From date and a To date, and then press the Run Report button to display a vendor activity list of all vendor activity during the period between the two dates.

The listing for each vendor activity in the vendor activity list in both sections may include the vendor, the service that was run, the name of the loan pool for which the service was run, the total number of loans for which the service was run, the start date, the complete date, the turn time in hours, the number of hits, and the hit rate, which is the number of hits divided by the number of loans times 100.

In block 1445, the routine 1400 returns to block 1410 to enable the user to select another loan pool and/or another function.

In block 1450, the routine 1400 performs the Edit function in response to an instruction from the user. The edit function may display a list of the loans in the selected loan pool, with columns labeled LoanID, Marked for Editing, Marked Reason, Ext Loan ID (which is the same as Ext. ID described above), Borrower First Name, Borrower Last Name, Origination Date, FICO, Coupon, Loan Balance, and LTV.

A loan pool summary for the loan pool may be displayed in a band above the list of loans highlighted, for example, in yellow and listing, for example, a total number of loans in the loan pool, the last refresh date, the total balance of the loans in the loan pool, WA coupon, WA FICO, WA LTV, WA seasoning, WA maturity, lien type, performance, and amortization if the loans in the loan pool are mortgages. However, the loan pool summary is not limited to this information, and some of this information may be omitted and/or other information may be displayed.

A checkbox may be displayed next to each the loans to enable the user to select each loan individually, and a checkbox may be displayed at the top of the list to enable the user to select all of the loans simultaneously.

An edit button to edit the name of the loan pool may be displayed. Buttons for edit functions Move, Delete, Edit Selected Loan, UnMark, and Update Stats with Selection may be displayed.

The Move button when clicked moves loans that the user has selected by checking a checkbox to the loan queue or to another pool that the user selects from a drop-down box.

The Delete button when clicked permanently deletes the selected loans from the database after asking the user to confirm.

The Edit button can only be used when only one loan has been selected, and when clicked displays a pop-up window listing the loan data for the loan and enabling the user to edit the loan data.

The UnMark button when clicked unmarks loans that have been marked for editing.

The Update Stats with Selection button when clicked recalculates the loan pool summary for the loan pool displayed above the list of loans using only the loans that have been checked, and displays a Reset Stats button.

The Reset Stats button when clicked recalculates the loan pool summary using all of the loans in the list.

In block 1455, the routine 1400 returns to block 1410 to enable the user to select another loan pool and/or another function.

In block 1460, the routine 1400 performs the Delete function in response to an instruction from the user. The Delete function enables the user to permanently delete the selected loan pool and all of the loans in the loan pool from the database.

In block 1465, the routine 1400 returns to block 1410 to enable the user to select another loan pool and/or another function.

FIGS. 16A and 16B illustrate an example of a vendor data integrating and auto-scheduling routine 1600 that is performed by the vendor data integrating engine and auto-scheduler 840 in FIG. 8.

In block 1605, the routine 1600 starts the auto-scheduler at a predetermined time each day, for example, at 6 PM. However, the auto-scheduler may be started at other times of the day, or at other intervals, or only on business days, or according to any schedule that may be desired. Starting later in the day may provide advantages such as being able to process scheduled services set by users late in the day, and quicker turnaround due to off-peak usage of the loan-data vendors' services.

In block 1610, the routine 1600 checks to see if any services are scheduled to run that day, or were scheduled to run since the last time the auto-scheduler was run. If not, the routine 1600 proceeds to block 1699, where the routine 1600 ends.

In block 1615, the routine 1600 identifies the services that are scheduled to be run.

Beginning in opening loop block 1620, the routine 1600 runs each of the services according to a predetermined stacking order. Certain vendor loan-data services require vendor loan data provided by other vendor loan-data services, so those certain vendor loan-data services may fail if they are run before the vendor loan-data services that provide the vendor loan data the certain vendor loan-data services require.

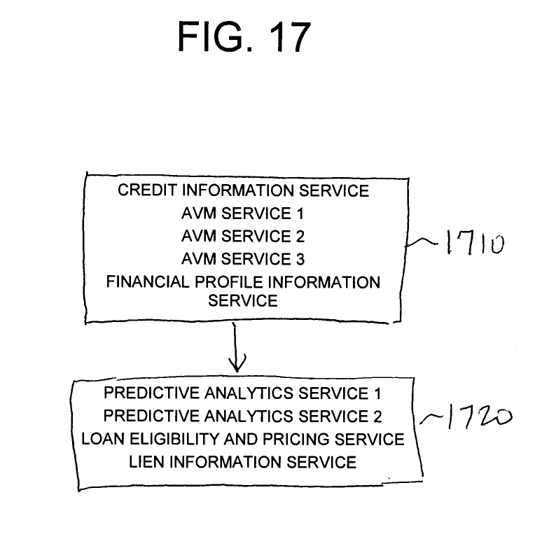

FIG. 17 illustrates an example of a predetermined stacking order that may employed by the routine 1600. For example, Credit Information Service, AVM Service 1, AVM Service 2, AVM Service 3, and Financial Profile Information Service described in detail above are run in a first level 1710 in the stacking order. Next, Predictive Analytics Service 1, Predictive Analytics Service 2, Loan Eligibility and Pricing Service, and Lien Information Service described in detail above are run in a second level 1720 in the stacking order. Generally, services in the same stacking level may be run in any order within that stacking level. However, there may be certain orders within the same stacking level that may result in greater efficiency and/or reduced run time and/or provide other benefits. Furthermore, some of the services listed in FIG. 17 may be omitted and/or other services may be added.

Beginning in opening loop block 1625, the routine 1600 obtains loan data required to run the current service for each user having a loan pool for which the current service is to be run.

Beginning in opening loop block 1630, the routine 1600 obtains loan data required to run the current service for each loan pool for which the current service is to be run for the current user.

In block 1635, the routine 1600 creates a formatted data file complying with the current service's requirements for the current loan pool for the current user. The formatted data file is a file that has a format in which the current service requires user loan data to be submitted in order to obtain vendor loan data.

Beginning in opening loop block 1640, the routine 1600 obtains loan data required to run the current service for each loan of the current loan pool for the current user.

In block 1645, the routine 1600 extracts loan data required to run the current service for the current loan from the loan pool data file for the current loan pool for the current user, and stores the extracted loan data in the formatted data file for the current loan pool for the current user.

In closing loop block 1650, the routine 1600 iterates back to opening loop block 1640 to process the next loan for the current loan pool if there is one, and if not, proceeds to block 1655.

In block 1655, the routine 1600 stores the formatted data file for the current loan pool containing the extracted loan data.

In closing loop block 1660, the routine 1600 iterates back to opening loop block 1630 to process the next loan pool for the current user if there is one, and if not, proceeds to closing loop block 1665.

In closing loop block 1665, the routine 1600 iterates back to opening loop block 1625 to process the next user if there is one, and if not, proceeds to block 1670.

In block 1670, the routine 1600 submits the formatted data files for all loan pools for which the current service is to be run for all users.

In block 1675, the routine 1600 determines whether the current service is an asynchronous service. An asynchronous service is a service that does not substantially immediately transmit the vendor data file in response to the formatted data file, but requires periodic checking to see if the vendor data file is ready. If the current service is not an asynchronous service, that means it is a synchronous service that substantially immediately transmits the vendor data file in response to the formatted data file. If the routine 1600 determines that the current service is an asynchronous service, the routine proceeds to block 1680. If the routine determines that the current service is a synchronous service, the routine 1600 proceeds to block 1683.

In block 1680, the routine 1600 periodically checks with the current vendor until the vendor data files are ready.

In block 1683, the routine 1600 receives and stores the vendor data files for all users.

In block 1685, the routine 1600 extracts the vendor data from the vendor data files.

In block 1687, the routine 1600 stores the vendor data in the corresponding loan pool data files for all users with a timestamp indicating the date and time the vendor data was obtained, and archives the previous vendor data for trending and analysis, for example, by storing the previous vendor data in an integration history table. While this description refers to storing the vendor data in a loan pool data file, this is merely an example, and the loan pool data and the vendor data may be stored in any manner known to one of ordinary skill in the art. For example, the loan pool data may be stored in one file, and the vendor data may be stored in another file, or in a plurality of files, one for each loan-data vendor. As another example, the various data elements of the loan pool data and the vendor data may be stored in tables in a database that may be accessed by a programming language such as SQL.

In closing loop block 1690, the routine 1600 iterates back to opening loop block 1620 to process the next service if there is one, and if not, proceeds to block 1699, where the routine 1600 ends.

FIG. 18 illustrates an example of a reporting and alerting routine 1800 that is performed by the reporting and alerting engine 850 in FIG. 8.

In block 1805, the routine 1800 displays the loan pools in response to an instruction from the user.

In block 1810, the routine 1800 selects loan pools from the displayed loan pools in response to an instruction by the user. The routine 1800 may enable the user to select loan pools by displaying a list of the loan pools and allowing the user to click on the name of a loan pool and then click on a LinkButton labeled Add, or by allowing the user to select multiple loan pools at once by holding down the control key while clicking the names of the loan pools and then clicking on the Add button. This list may be displayed at the top of a plurality of tabs for different functions that may be clicked by a user to select a function. However, as will be apparent to one of ordinary skill in the art, other techniques may be used to enable the user to select the loan pools.

In block 1815, the routine 1800 selects a function in response to an instruction from the user. The functions that can be selected are create a search, which may be saved as a saved search or a Radar, run a saved search, run a Radar, and generate a report. The routine 1800 may enable the user to select a function by displaying tabs that the user can click to select a function. However, as will be apparent to one of ordinary skill in the art, other techniques may be used to enable the user to select a function.

In block 1820, the routine 1800 creates a search in response to the user choosing to create a search in block 1815.

In block 1825, the routine 1800 displays one of a plurality of pre-defined search pages in response to an instruction from the user.

The pre-defined search pages may include Statistics, Credit, Income, Collateral, Liens, Risk Models, and Valuation search pages.

Search elements on the Statistics search page may include Last Updated, Loan Category, Product Group, Mortgage Type, Lien Type, Product Type, Loan Purpose, ARMs Next Adjustment, Loan Size, Coupon, Occupancy, Documentation, Seasoning, Amortization Term; Prepayment Penalty, Mortgage Insurance, and Origination.

Search elements on the Credit search page may include Risk of Delinquency, FICO Score, Vantage Score, Bankruptcy Score, Liability Meter, Mortgage Payment, Mortgage Credit, General Credit, and Credit Accounts.

Search elements on the Income search page may include Employment Type, Annual Wage Income, URLA Total Income, Ability to Pay Index, and Income360.

Search elements on the Collateral search page may include LTV, CLTV, HELOC Analysis, Property Value, Confidence Analysis, Value Forecast, Collateral Integrity, Collateral Validation, Property Type, and Geographic Location.

Search elements on the Lien search page may include Liens and Discrepancy.

Search elements on the Risk Models search page may include No Hits, Delinquency, Default, Prepayment, Loss Severity, and Cumulative Loss.

Search elements on the Valuation search page may include Loan Eligibility.

In block 1830, the routine 1800 displays the search results. The first time the search results are displayed, they will include all of the loans in the selected loan pool. The search results may be displayed as a loan pool summary for the loan pool in a band at the top of the search elements listed on the displayed search highlighted, for example, in yellow and listing, for example, a total number of loans in the selected loan pools, the last refresh date, the total balance of the loans in the selected loan pools, WA coupon, WA FICO, WA LTV, WA seasoning, WA maturity, and performance if the loans in the loan pool are mortgages. However, the loan pool summary is not limited to this information, and some of this information may be omitted and/or other information may be displayed. Each successive time the search results are displayed the search results will be updated to reflect only those loans that meet the latest search criteria. This enables the user to continually refine the search until the user is satisfied with the results.

In block 1835, the routine 1800 adds a search element listed on the displayed search page to the current search if the user selects a search element, and then returns to block 1830 to display the search results with the added search element; otherwise the routine 1800 proceeds to block 1840.

The routine 1800 may enable the user to add a search element to the search by displaying a list of the search elements on the current data search page; providing, for each search element, one or more data entry fields into which the user can enter search criteria, and/or one or more buttons that the user can press to select one or more pre-defined search criteria; and providing a LinkButton labeled Add by each search element that the user can press to add the search element with the search criteria entered and/or selected by the user to the current search. The routine 1800 may perform error checking to inform the user that invalid data has been entered and prompt the user to reenter the data. The routine 1800 may perform the error checking by checking the data the user has entered against a database of all of the LoanHD data elements listing the required format and permissible values or range of values for each data element.

Some search elements may have Borrower and Co-Borrower buttons to enable different search criteria to be entered for a borrower and a co-borrower. For example, the FICO Score search element may have Borrower and Co-Borrower buttons.

A delete button may also be provided for each search element to enable the user to delete the search element from the list of search elements. A Refresh Search Element List button may be provided at the top of the list of search elements to restore any search elements that may have been deleted.

When a search element is added to the current search, the search criteria may be entered into a blank area on the right side of the search page in line with the search element, along with a label Borrower or Co-borrower if applicable. The number of loans in the current search results that meet the search criteria may be displayed in the blank area next to the search criteria. The loan pool summary that is highlighted in yellow and displayed at the top of the search elements is automatically updated to display the effect of adding the search element to the current search, thereby providing instant feedback to the user. A delete button may be provided in the blank area next to the number of loans to enable the user to delete the search element from the current search.

In block 1840, the routine 1800 determines whether the user wants to display another search page in response to an instruction from the user. If yes, the routine 1800 returns to block 1825 to display another search page. If no, the routine 1800 proceeds to block 1845.

In block 1845, the routine 1800 determines whether the user wants to move the loans in the current search results and/or save the current search in response to an instruction from the user. If yes, the routine proceeds to block 1850. If no, the routine 1800 proceeds to block 1855.

In block 1850, the routine 1800 moves the loans in the current search results and/or saves the current search as either a search or a Radar in response to an instruction from the user. The user can move the loans to the loan queue or to an existing loan pool, or create a new loan pool and move the loans to the new loan pool. The user can save the search as a new search or can update an existing search, or the user can save the search as a new Radar or can update an existing Radar.

The difference between a search and a Radar is that a Radar will automatically display an alert on a Radar tab in a reporting and alerting screen displayed by the reporting and alerting engine, and may be set to display an alert on specific reports that can be displayed in block 1430 in the loan/pool managing and analyzing routine 1400 in FIG. 14. A Radar will automatically run after each refresh of the vendor loan data by the auto-scheduler. Also, a Radar can be manually run on demand from table of Radars on a Radar tab as will be described below. The LoanHD system 800 may be configured to e-mail a notification that a Radar has been triggered to one or more recipients designated by the user.

Radars identify changes in metrics that may be of concern to a user, and are designed to bring these changes to the attention of the user as soon as possible so the user can take appropriate action if necessary to minimize potential losses. For example, a Radar may be set to monitor delinquent payments so that the Radar will be triggered if any borrower has a new delinquent payment on any active account since the last refresh. This will alert the user to take a closer look at the loan to identify any actions that need to be taken to minimize potential losses on the loan.

The routine 1800 may enable the user to move the loans in the current search results and/or save the current search as either a search or a Radar by displaying a Move Loans button, a Save Search button, and a Save Radar button at the top of the list of search elements on each search page.

When the user clicks the Move Loans button, the routine 1800 may display a Move pop-up window with a checkbox labeled Move selected Loan(s) to the Loan Queue, a drop-down box to select the name of an existing loan pool, a Save button, a Cancel button, and an X button to close the pop-up window.

When the user clicks on the Save Search button, the routine 1800 may display a Save Settings pop-up window with a Create New section with a Name text box, a Save button, and a Save As button; an Update Existing section with a drop-down box to select the name of an existing loan pool and a Save button; and an X button to close the Save Settings pop-up window.

When the user clicks on the Save Radar button, the routine 1800 may display a Radar Settings pop-up window having a Page Assignments section with a listbox with scroll bar listing the pages (which may also be referred to as pages or views) to which the Radar can be assigned; a Create New section with a Name text box, a Save button, and a Save As button; an Update Existing section with a drop-down box to select the name of an existing Radar, and a Save button; an E-mail Notification section with a drop-down box to select an existing e-mail address from a list, a text box to enter a new e-mail address, an Add to List button to add the new e-mail address to the list, and Add to Radar button to add the selected existing e-mail address or the new e-mail address to the recipients of the Radar; a Recipients section with a listbox with scroll bar listing the recipients of the Radar, and a Remove from Radar button to remove any e-mail address that has been clicked in the listbox with scroll from the recipients of the Radar; and an X button to close the Radar Settings pop-up window.

The listbox listing the pages to which the Radar can be assigned may list, for example, Statistics pages (Product Group, Product Type/Loan Purpose, Loan Size, Coupon, Occupancy, Documentation, Seasoning, Amortization, and Mortgage Insurance), Credit pages (FICO Score, VantageScore, Bankruptcy Score, Risk of Delinquency, Liability Meter, Mortgage Payment, Mortgage Credit, General Credit, and Credit Accounts), Income pages (Income, Age, Ability to Pay Index, and Income360), Collateral pages (LTV/CLTV, HELOC Analysis, Value Analysis, Value Forecast, Collateral Integrity, Confidence Analysis, Collateral Valuation, Property Type, and Geographic Concentration), Liens pages (Silent Liens and Recorded Liens), Risk Models pages (Delinquency, Default, Prepayment, Loss Severity, and Cumulative Loss), and Valuation pages (Sale/Eligibility). The user may click on a page to select that page, or may hold down the control key while clicking on pages to select multiple pages. However, the Radar is not limited to these pages, and some of these pages may be omitted and other pages may be added.

In block 1855, the routine 1800 returns to block 1815 to enable the user to select another function.

In block 1860, the routine 1800 runs a saved search selected by the user in response to the user choosing to run a saved search in block 1815. The routine 1800 may enable the user to select a saved search by displaying a Saved Searches tab that when clicked by the user displays a list of the saved searches with columns labeled Refresh Search, Results, Search Name, Loan Category, Criteria, Excluded Loans, Pools, Created, Last Modified, Data Download, and Delete. LinkButtons labeled Refresh All and Choose Report Elements may be displayed at the top of the list.

The Refresh Search column may contain a refresh button that the user can click on to run the saved search.

The Results column may list the number of loans that are found when the search is refreshed.

The Search Name column may list the name of the saved search as a LinkButton that may be clicked to display the results of the saved search as will be described below.

The Loan Category column may list the category of the loans in the saved search, such as Mortgage.

The Criteria column may contain a LinkButton labeled view that may be clicked to display a pop-up window listing the search criteria, i.e., the names of the search elements in the saved search and the values of the search elements, with an X button to close the pop-up window.

The Excluded Loans column may list the number of loans in the select loan pools that have been excluded from the saved search as a LinkButton that when clicked will display an Excluded Loans pop-up window listing the loans that have been excluded. The pop-up window may list the LoanID of each excluded loan and the loan pool to which each excluded loan is assigned. The LoanID may be displayed as a link that the user can point to using a mouse or other pointing device to display a pop-up window listing Loan ID, Ext. ID, borrower name, co-borrower name, and a selection Loan Statement: Open, with a PDF icon by the word Open. The word Open may be a LinkButton that when clicked will display a loan statement for the loan. The loan statement is a multi-vendor loan level report that lists all of the metrics, analyses, and other information that is available for the selected loan, and is generated by the subroutine 600 in FIG. 6. The loan statement was described in greater detail above in connection with box 1430 in FIG. 14. A checkbox may be provided by each loan, and a button labeled Remove from Exclusion may be provided that when clicked will remove any checked loans from the exclusion so that they will be included in the results of the saved search. A button labeled Close and an X button may be provided, both of which will close the Excluded Loans pop-up window.

The Pools column may list the number of loan pools that the saved search was run against as a clickable button that when clicked will display a pop-up window listing the names of the loan pools.

The Created column may list the date the saved search was created.

The Last Modified column may list the date the saved search was last modified.

The Data Download column may contain a LinkButton that may be labeled with a spreadsheet file extension such as XLS that when clicked will display a file download window with options to open or save a spreadsheet file containing the data elements for the loans in the results for the saved search, or to cancel the download.

The Delete column may contain a LinkButton labeled Delete that when clicked will delete the saved search.

In block 1863, the routine 1800 displays or saves the search results if the user chooses to do so, and then proceeds to block 1865. The user may choose to display the search results by clicking on the search name in the Search Name column. The routine 1800 may display the search results by displaying a reporting page to be described below, with the search results being displayed as a loan pool summary for the loan pools against which the search was run in a band at the top of the reporting page highlighted, for example, in yellow and listing, for example, a total number of loans in the loan pools, the total balance of the loans in the loan pools, WA coupon, WA FICO, WA LTV, WA seasoning, WA maturity, and performance if the loans in the loan pools are mortgages. However, the loan pool summary is not limited to this information, and some of this information may be omitted and/or other information may be displayed.

In block 1865, the routine 1800 proceeds to block 1825 if the user chooses to edit the saved search; otherwise the routine proceeds to block 1868. The user may choose to edit the saved search by clicking on the name of the saved search in the Search Name column to display a reporting page to be described below, and then clicking on one of the search pages described above, which will cause the routine 1800 to proceed to block 1825 to enable the user to edit the search. The reporting page may already be displayed when the routine 1800 reaches block 1865 if the user chose to display the search results in block 1863.

In block 1868, the routine 1800 returns to block 1815 to enable the user to select another function.

In block 1870, the routine 1800 runs a Radar selected by the user in response to the user choosing to run a Radar in block 1815. The routine 1800 displays a Radar tab with a table of saved Radars when the user chooses to run a Radar in block 1815. The table may have columns labeled Run Radar, Results, Alert, Alert Date, Radar Name, Data Download, Pools, Pages, Created, Last Modified, Criteria, Excluded Loans, Edit, and Status. A LinkButton labeled Run All Radars may be displayed at the top of the list.

The Run Radar column may contain a refresh button that the user can click on to run the Radar.

The Results column may list the number of loans that are found when the Radar is run.

The Alert column may display a red ringing bell icon if any loans are found when the Radar is run. However, another color may be used instead of red, and another icon may be used instead of the ringing bell icon.

The Alert Date column may display the last date the Radar was triggered.

The Radar Name column may list the name of the Radar as a LinkButton that may be clicked to display results for the Radar as will be described below.

The Data Download column may contain a LinkButton that may be labeled with a spreadsheet file extension such as XLS that when clicked will display a file download window with options to open or save a spreadsheet file containing the data elements for the loans in the results for the Radar, or to cancel the download.

The Pools column may list the number of loan pools that the Radar was run against as a clickable button that when clicked will display a pop-up window listing the names of the loan pools.

The Pages column may list the number of pages (or reports or views) to which the Radar was assigned as a clickable button that when clicked will display a pop-up window listing the names of the pages.

The Created column may list the date the Radar was created.

The Last Modified column may list the date the Radar was last modified.

The Criteria column may contain a LinkButton labeled view that may be clicked to display a pop-up window listing the Radar criteria, i.e., the names of the search elements and the values of the search elements, with an X button to close the pop-up window.

The Excluded Loans column may list the number of loans in the select loan pools that have been excluded from the Radar as a LinkButton that when clicked will display an Excluded Loans pop-up window listing the loans that have been excluded. The pop-up window may list the LoanID of each excluded loan and the loan pool to which each excluded loan is assigned. The Loan ID is displayed as a link that the user can point to using a mouse or other pointing device to display a pop-up window listing Loan ID, Ext. ID, borrower name, co-borrower name, and a selection Loan Statement: Open, with a PDF icon by the word Open. The word Open is a LinkButton that when clicked will display a loan statement for the loan. The loan statement is a multi-vendor loan level report that lists all of the metrics, analyses, and other information that is available for the selected loan, and is generated by the subroutine 600 in FIG. 6. The loan statement was described in greater detail above in connection with box 1430 in FIG. 14. A checkbox may be provided by each loan, and a button labeled Remove from Exclusion may be provided that when clicked will remove any checked loans from the exclusion so that they will be included in the results of the saved search. A button labeled Close and an X button may be provided, both of which will close the Excluded Loans pop-up window.

The Edit column may contain a LinkButton that when clicked will display a pop-up window with LinkButtons labeled Delete and Disable if the Radar is active, or Delete and Reset if the Radar is disabled. Clicking Delete will delete the Radar. Clicking Disable will change the status of the Radar from Active to Disabled. Clicking Reset will change the status of the Radar from Disabled to Active.

The Status column may display Active if the Radar is active, and Disabled if the Radar is disabled.

The Radar tab on which the Radar table described above is listed may also list one or more pre-defined Radars. Examples of such pre-defined Radars may include Credit Alerts, such as Non-Prime Credit, Credit Accounts Max Limit, Delinquent Payments, Increased Liabilities, and New Mortgage Accounts; Collateral Alerts, such as Negative Equity, Loans Above OLTV; and Depreciating Values; and Lien Alerts, such as Newly Filed Liens.

The Non-Prime Credit Radar may identify loans where the borrower's current credit score has fallen below the Prime score range. A credit score of 660 or higher represents the Prime credit category.

The Credit Accounts Max Limit Radar may identify loans where the borrower has hit the maximum limit on any active credit account.

The Delinquent Payments Radar may identify loans where the borrower has a new delinquent payment on any active credit account.

The Increased Liabilities Radar may identify loans where the borrower has increased total liabilities since the last refresh date.

The New Mortgage Accounts Radar may identify loans where the borrower has open a new mortgage account since the last refresh date.

The Negative Equity Radar may identify loans where the loan balance is greater than the current refreshed property value.

The Loans Above OLTV Radar may identify loans where the property currently has less equity than when the loan was originated based on a refreshed property value.

The Depreciating Values Radar may identify loans where AVM Service 1 has predicted that value of the property will decline more than 2% within the next 6 months.

The Newly Filed Liens Radar may identify loans where a new liens has been filed on the property since the last refresh of title data from Lien Information Service.

However, although examples of pre-defined Radars have been given above, other pre-defined Radars may be provided.

The names of the pre-defined Radars may be LinkButtons that when clicked will display a pop-up window including a list of the available loan pools, a Run Search button, and an X button to close the pop-up window. The user may select one loan pool by clicking on the name of the loan pool to be selected, or may select more than one loan pool by holding down the control key while clicking the names of the loan pools to be selected. The user can then run the pre-defined Radar on the selected loan pools by clicking the Run Search button. The use can click the X button to close the pop-up window without running the Radar.

In block 1873, the routine 1800 displays the Radar results if the user chooses to do so, and then proceeds to block 1875. The user may choose to display the Radar results by clicking on a saved Radar name in the Radar Name column of the Radar table, or by running one of the pre-defined Radars as described above.

If the user clicked on a saved Radar name in the Radar Name column of the Radar table, the routine 1800 may display the Radar results by displaying a reporting page to be described below, with the Radar results being displayed as a loan pool summary for the loan pools against which the Radar was run in a band at the top of the reporting page highlighted, for example, in yellow and listing, for example, a total number of loans in the loan pools, the total balance of the loans in the loan pools, WA coupon, WA FICO, WA LTV, WA seasoning, WA maturity, and performance if the loans in the loan pools are mortgages. However, the loan pool summary is not limited to this information, and some of this information may be omitted and/or other information may be displayed.

If the user ran one of the pre-defined Radars, the routine 1800 may display the Radar results by displaying one of the search pages described above, which may display the Radar results as a loan pool summary for the loan pools against which the Radar was run in a band at the top of the search page highlighted, for example, in yellow and listing, for example, a total number of loans in the loan pools, the total balance of the loans in the loan pools, WA coupon, WA FICO, WA LTV, WA seasoning, WA maturity, and performance if the loans in the loan pools are mortgages. However, the loan pool summary is not limited to this information, and some of this information may be omitted and/or other information may be displayed.

In block 1875, the routine proceeds to block 1825 if the user chooses to edit the Radar; otherwise the routine proceeds to block 1878. If the user clicked on a saved Radar name in the Radar Name column of the Radar table, the reporting page to be described below will be displayed, and the user may choose to edit the Radar by clicking on one of the search pages described above, which will cause the routine 1800 to proceed to block 1825 to enable the user to edit the Radar. If the user ran one of the pre-defined Radars, one of the search pages described above will already be displayed, and the user may choose to edit the Radar by changing the search elements and/or the values of the search elements on the displayed search page, or clicking on another one of the search pages described above, both of which will cause the routine 1800 to proceed to block 1825 to enable the user to edit the Radar.

In block 1878, the routine 1800 returns to block 1815 to enable the user to select another function.

In block 1880, the routine 1800 selects a report selected by the user in response to the user choosing to generate a report in block 1815. The routine 1800 may enable the user to select a report by displaying a reporting page with a drop-down box listing pre-defined reports (or pages or views) and a LinkButton labeled Choose Report Elements to enable the user to create a custom report.

The pre-defined reports may be divided into categories of Statistics, Credit, Income, Collateral, Liens, and Risk Models.

The Statistics category may include Basic, Loan Level Data, Property Address, Borrower Mailing Address, Product Type, Loan Size, Coupon, Amortization, Seasoning, and Mortgage Insurance reports.

The Credit category may include FICO Score, VantageScore, Bankruptcy Score, Risk Of Delinquency, Total Liabilities (Non Mortgage), Mortgage Payment, Mortgage Credit, Non Mortgage Credit Utilization, General Credit, and Credit Accounts reports.

The Income category may include Ability to Pay Index, and Income360 Index reports.

The Collateral category may include Loan-to-Value, HELOC Analysis, Property Valuation, Value Forecast, Collateral Integrity, Collateral Value Validation, and Geography reports.

The Liens category may include Liens and Lien Holders reports.

The Risk Models category may include Delinquency, Default, Loss Severity, and Cumulative Loss reports.

Although specific examples of pre-defined reports have been given above, other pre-defined reports may be provided.

Selecting one of the pre-defined reports will display a list of the loans in the selected loan pools with one loan per line and with data elements relative to that report in columns. Most of the column headings may be a LinkButton that when clicked will sort the list by the data that column, alternating between sort down and sort up with each click.

A loan pool summary for the selected loans pool may be displayed in a band at the top of the list of loans highlighted, for example, in yellow and listing, for example, a total number of loans in the selected loan pools, the total balance of the loans in the selected loan pools, WA coupon, WA FICO, WA LTV, WA seasoning, WA maturity, and performance. However, the loan pool summary is not limited to this information, and some of this information may be omitted and/or other information may be displayed.

A checkbox may be displayed next to each the loans in the list to enable the user to select each loan individually, and a checkbox may be displayed at the top of the list to enable the user to select all of the loans simultaneously. A LinkButton labeled Select All may be displayed above the list of loans that when clicked will select all of the loans.

An Edit Functions section may be displayed above the list of loans and may include LinkButtons labeled Exclude Selected Loans From Search, Mark Selected Loans for Editing, Unmark, Update Search with Selected Loans, and Delete.

The Exclude Selected Loans from Search button when clicked removes selected loans from the list of loans and recalculates the loan pool summary displayed at the top of the report to exclude the selected loans.

The Mark Selected Loans for Editing button when clicked displays a Mark for Editing pop-up window with a combo box with the instruction “Please select a reason for marking these loans or create a new one by entering the name of the reason,” a Save button, a Cancel button, and an X button to close the Mark for Editing pop-window. The user can enter a reason in the combo box, or use the drop-down portion of the combo box to select a pre-defined reason, such as Test, Investor Loans, or Unknown CLTV. This causes a green check mark icon to be entered into a Marked for Editing data element for each loan that was selected, and causes the reason entered into the combo box to be entered into a Marked Reason data element for each loan that was selected. However, another color may be used instead of green, and another icon may be used instead of the check mark icon.

The UnMark button when clicked unmarks loans that were marked for editing using the Mark Selected Loans for Editing button.

The Update Search with Selected Loans when clicked recalculates the loan pool summary displayed at the top of the report to include only the loans that have been selected, and displays a Reset Stats button.

The Reset Stats button when clicked recalculates the loan pool summary to include all of the loans in the list.

The Delete button when clicked deletes the selected loans from the loan pool and puts them into the loan queue after asking the user to confirm.

An Excluded Loans LinkButton is displayed under the Edit Functions. This button is the number of loans that have been excluded from the list. Clicking this button displays an Excluded Loans pop-up window listing the loans that have been excluded. The pop-up window may list the LoanID of each excluded loan and the loan pool to which each excluded loan is assigned. The LoanID may be displayed as a link that the user can point to using a mouse or other pointing device to display a pop-up window listing Loan ID, Ext. ID, borrower name, co-borrower name, and a selection Loan Statement: Open, with a PDF icon by the word Open. The word Open is a LinkButton that when clicked displays a loan statement. The loan statement is a multi-vendor loan level report that lists all of the metrics, analyses, and other information that is available for the selected loan, and is generated by the subroutine 600 in FIG. 6. The loan statement is described in greater detail above in connection with box 1430 in FIG. 14. A checkbox is provided by each loan, and a button labeled Remove from Exclusion may be provided that when clicked will remove any checked loans from the exclusion and return them to the list of loans so they will be included in the loan pool summary displayed at the top of the report. A button labeled Close and an X button may be provided, both of which will close the Excluded Loans pop-up window.

A LinkButton labeled Download All Data may be displayed above the loan pool summary that when clicked will display a file download window with options to open or save a spreadsheet file containing all of the data elements for the loans in the list, or to cancel the download. Any loans that have been excluded from the list will not be included in the download.

Buttons labeled Move Loans, Save Search, and Save Radar are displayed above the Edit Functions. The Move Loans button when clicked moves selected loans to the loan queue or to another loan pool. The Save Search button when clicked saves a search based on the current results. The Save Radar button when clicked saves the current results as a Radar. These functions are described in detail in the description of block 1850 in FIG. 18 above.

The Basic report may list LoanID, External ID, Last Updated, Marked for Editing, Marked Reason, # Borrowers, Borrower Name, Co-Borrower Name, Origination Date, and Loan Balance.

The Loan Level Data report may list LoanID, External ID, Last Updated, Mortgage Type, Product Group, Product Type, Occupancy Type, Occupancy Validated, and Documentation Type.

The Property Address report may list LoanID, External ID, Last Updated, Address, City, State, Zip, and Zip4.

The Product Type report may list Loan ID, Product Type, Loan Balance, Origination Date, Next Adjustment Date, Next Adjustment Days, Coupon, Index Type, Index, Margin, Expected New Rate, and Difference (the Expected New Rate—the Coupon). Above the list of loans may be displayed the current LIBOR indices (1 year, 6 month, 3 month, 1 month) and the current Treasury indices (Prime, 3-year T-bill, 2-year T-bill, 1-year T-bill, MTA (12-month Treasury average), 1-year CMT (Constant Maturity Treasury rate), and 3-month T-bill. However, other indices may be displayed.

The Loan Size report may list Loan ID, External ID, Last Updated, Original Loan Balance, Current Loan Balance, Property Type (e.g., 1-family, PDUs, manufactured, etc.), and three eligibility columns, Agency Conforming, Agency High Cost, and Non Agency. A green checked box icon may be displayed in the Agency Conforming column if the loan is an agency conforming loan, and a red checked box icon may be displayed in the Agency Conforming column if the loan is not an agency conforming loan. A green checked box icon may displayed in the Agency High Cost column if the loan is an agency high cost loan, and a green checked box icon may be displayed in the Non Agency column if the loan is a non agency loan.

Reports that contain metrics obtained from loan-data vendors may have graphical features that allow the user to visualize the metrics.

For example, the FICO Score report may list LoanID, External ID, Last Updated, Original FICO Score, Refreshed FICO Score, Difference in FICO Score (Refreshed—Original), Trend, Graph, Classification (e.g., Prime, Alt-A, or Subprime), and a horizontal bar graph or gauge showing the FICO score. Other reports may have a horizontal bar graph or gauge showing a metric for those reports.

Buttons labeled Borrower and Co-Borrower may be displayed at the top of the list of loans to enable the user to display the borrower's FICO score and the co-borrower's FICO score. Similar buttons may be provided in other reports where there are multiple values for a metric in the report or multiple types of metrics. Some reports may display an Average button to display an average of a metric for the borrower and the co-borrower.

The Trend may be a graphical indicator or gauge indicating the direction of a change in the FICO score in a color that indicates whether the change is desirable or undesirable. For example, if the FICO score has decreased, this is a undesirable change, so the graphical indicator for the Trend may be a red arrow pointing down at a 45° angle, with red indicating that the change is undesirable. If the FICO score has increased, this is a desirable change, so the graphical indicator for the trend may be a green arrow point up at a 45° angle, indicating a desirable change. If the FICO score is unchanged, the graphical indicator for the trend may be a straight horizontal black line, indicating that the FICO score has not changed.

However, some reports may use a red or green upward pointing triangle and a red or green downward pointing triangle instead of the red or green arrows described above. However, other graphical indicators may be used.

The Graph may be a clickable chart icon representing a graph or chart that when clicked will display a pop-up window with a trend graph of the FICO score for that loan displayed as a vertical bar graph.

The Property Value report may list LoanID, External ID, Last Updated, Original Property Value/Purchase Price, Refreshed Property Value, Difference in Property Value (Refreshed—Original), Value Confidence, Negative Equity Warning, Negative Equity Amount, and Lien Information Service Quick Sale $. A drop-down box labeled User vendor data may be displayed at the top of the list of loans with selections AVM Service 1, AVM Service 3, and average to enable the report to be based on data obtained from AVM Service 1, data obtained from AVM Service 3, or an average of the data obtained from AVM Service 1 and the data obtained from AVM Service 3. A similar drop-down box may be displayed on any other report where it is appropriate.

Other reports not specifically discussed above may display data elements relevant to those reports and may have any of the features discussed where appropriate.

In block 1883, the routine 1800 determines whether the user has selected a custom report. If yes, the routine proceeds to block 1885; if no, this means the user has selected a pre-defined report, so the routine proceeds to block 1893.

In block 1885, the routine 1800 displays a data element page in response to an instruction from the user.

In block 1888, the routine 1800 selects data elements from the data element page in response to instructions from the user.

In block 1890, the routine 1800 determines whether the user wants to display another data element page. If yes, the routine 1800 returns to block 1885; if no, the routine 1800 proceeds to block 1893.

In block 1893, the routine 1800 displays the pre-defined report that was selected in block 1880, or displays or saves the custom report that was generated in blocks 1885-1890, and then proceeds to block 1895.

In block 1895, if the report is the pre-defined report, the routine 1800 performs any of the Edit Functions described above that may be requested by the user. Otherwise, the routine 1800 proceeds to block 1898.

In block 1898, the routine 1800 returns to block 1815 to enable the user to select another function.

In blocks 1885-1890 discussed above, the routine 1800 generates a custom report including data elements selected from data elements pages in response to instructions from the user.

The data elements pages list all of the available data elements, and may include a Borrower data elements page, a Co-Borrower data elements page, a Loan-Level data elements page, a Property data elements page, and a Predictive Analytics data elements page. Each of these pages may include Borrower Data, Co-Borrower Data, Loan-Level Data, Property Data, and Predictive Analytics Data buttons that the user can click to display any of the pages, and Download and Save Report buttons that the user can click to download or save the custom report.

The Download button when clicked displays a file download window with options to open or save a spreadsheet file containing the selected data elements, or to cancel the download.

The Save Report button when clicked displays a Save Settings pop-up window with a Create New section with a Name text box, a Save button, and a Save As button; an Update Existing section with a drop-down box to select the name of an existing report and a Save button; and an X button to close the Save Settings pop-up window.

The data elements listed on the Borrower data elements page may include Borrower First Name, Borrower Middle Name, Borrower Last Name, Borrower Mailing Address Street, Borrower Mailing Address City, Borrower Mailing Address State, Borrower Mailing Address Postal Code, Borrower Mailing Address Postal Code+4, Borrower Is Self Employment, Borrower Age, Borrower Annual Wage Income, Borrower Original FICO, Borrower FICO, Previous FICO, Borrower FICO Grade, Borrower VantageScore, Previous Borrower VantageScore, Borrower VantageScore Category, Borrower VantageScore Grade, Borrower Bankruptcy Score, Borrower Credit Balance of All Accounts % Change, Borrower Credit Balance of All Accounts Current, Borrower Credit Balance of All Accounts Current Previous, Borrower Mortgage Accounts Opened Last 12 Months, Borrower Mortgage Accounts Currently Active, Borrower Mortgage Accounts Currently Active Previous, Borrower Non-Mortgage Utilization Rate, Borrower Active Acts With Current Balance>0, Borrower Trades Opened In Past 12 Months, Borrower Trades Opened In Past 12 Months Previous, Borrower Inquiries In Last 6 Months, Borrower Inquiries In Last 6 Months Previous, Borrower Bankruptcy, Borrower Bankruptcy Previous, Borrower Tax Liens, Borrower Collections, Borrower Charge-Offs, Borrower Bankcard Total Current Balance Of All Trades, Borrower Bankcard Ratio Of Total Current Balance To High Credit Limit, Borrower Revolving Total Current Balance Of All Trades, Borrower Revolving Ratio Of Total Current Balance To High Credit Limit, Borrower Installment Total Current Balance Of All Trades, Borrower Installment Ratio Of Total Current Balance To High Credit Limit, Borrower Finance Total Current Balance Of All Trades, Borrower Finance Ratio Of Total Current Balance To High Credit Limit, Borrower Retail Total Current Balance Of All Trades, Borrower Retail Ratio Of Total Current Balance To High Credit Limit, Borrower FICO 60+ Rate Interval, Borrower FICO 90+Rate Interval, Borrower FICO CO+ Rate Interval, Borrower FICO BK+ Rate Interval, Borrower VantageScore 60+ Rate Interval, Borrower VantageScore 90+ Rate Interval, Borrower VantageScore CO+ Rate Interval, and Borrower VantageScore BK+ Rate Interval.

The data elements listed on the Co-Borrower data elements page may include Co-Borrower First Name, Co-Borrower Middle Name, Co-Borrower Last Name, Co-Borrower Mailing Address Street, Co-Borrower Mailing Address City, Co-Borrower Mailing Address State, Co-Borrower Mailing Address Postal Code, Co-Borrower Mailing Address Postal Code+4, Co-Borrower Is Self Employment, Co-Borrower Age, Co-Borrower Annual Wage Income, Co-Borrower Original FICO, Co-Borrower FICO, Previous Co-Borrower FICO, Co-Borrower FICO Grade, Co-Borrower VantageScore, Previous Co-Borrower VantageScore, Co-Borrower VantageScore Category, Co-Borrower VantageScore Grade, Co-Borrower Bankruptcy Score, Co-Borrower Credit Balance of All Accounts % Change, Co-Borrower Credit Balance of All Accounts Current, Co-Borrower Credit Balance of All Accounts Previous, Co-Borrower Mortgage Accounts Opened Last 12 Months, Co-Borrower Mortgage Accounts Currently Active, Co-Borrower Mortgage Accounts Currently Active Previous, Co-Borrower Non-Mortgage Utilization Rate, Co-Borrower Active Acts With Current Balance>0, Co-Borrower Trades Opened In Past 12 Months, Co-Borrower Trades Opened In Past 12 Months Previous, Co-Borrower Inquiries In Last 6 Months, Co-Borrower Inquiries In Last 6 Months Previous, Co-Borrower Bankruptcy, Co-Borrower Bankruptcy Previous, Co-Borrower Tax Liens, Co-Borrower Collections, Co-Borrower Charge-Offs, Co-Borrower Bankcard Total Current Balance Of All Trades, Co-Borrower Bankcard Ratio Of Total Current Balance To High Credit Limit, Co-Borrower Revolving Total Current Balance Of All Trades, Co-Borrower Revolving Ratio Of Total Current Balance To High Credit Limit, Co-Borrower Installment Total Current Balance Of All Trades, Co-Borrower Installment Ratio Of Total Current Balance To High Credit Limit, Co-Borrower Finance Total Current Balance Of All Trades, Co-Borrower Finance Ratio Of Total Current Balance To High Credit Limit, Co-Borrower Retail Total Current Balance Of All Trades, Co-Borrower Retail Ratio Of Total Current Balance To High Credit Limit, Co-Borrower FICO 60+Rate Interval, Co-Borrower FICO 90+ Rate Interval, Co-Borrower FICO CO+ Rate Interval, Co-Borrower FICO BK+ Rate Interval, Co-Borrower VantageScore 60+ Rate Interval, Co-Borrower VantageScore 90+ Rate Interval, Co-Borrower VantageScore CO+ Rate Interval, and Co-Borrower VantageScore BK+ Rate Interval.

The data elements listed on the Loan-Level data elements page may include Last Updated, Origination Date, Loan Category, Product Group, Mortgage Type, Occupancy Type, Documentation, Lien Type, Product Type, Loan Purpose, Original Loan Amount, Current Loan Amount, Original Coupon, Current Coupon, Original Amortization Term (Months), Current Amortization Term (Months), Amortization Type, Seasoned (Months), Seasoned, Agency Conforming Eligible, High Cost Area Eligible, Current Payment Status, Previous Payment Status, Index Type, Index, Margin, Next Adjustment Date, Next Adjustment Date (Days), Expected New Rate, Initial Interest Rate Cap, Subsequent Interest Rate Cap, Lifetime Interest Rate Cap, Lifetime Max Rate (Ceiling), Lifetime Min Rate (Floor), Prepayment Penalty Indicator, Prepayment Penalty Type, Prepayment Penalty Term (Months), Mortgage Insurance Company Name, Mortgage Insurance Percent, Loan Modification Date, Loan Modification Reason, Loan Modification Type, Interest Only Indicator, Interest Only Term, Interest Only Adjustment Date, Balloon Indicator, HELOC, URLA Total Income, Source, Loan Officer Name, Underwriter, and Branch.

The data elements listed on the Property data elements page may include Property Address Street, Property Address City, Property Address State, Property Address County, Property Address Postal Code, Property Address Zip4, Property Type, Property Type Group, Region, Original Property Value/Purchase Price, Original Property Valuation Date, Original Property Valuation Type, Original LTV, Refreshed LTV, True CLTV, Synthetic CLTV, HELOC High Limit, HCLTV, HELOC Utilization Rate, Refreshed Property Value Average, Negative Equity Amount, Refreshed Property Value AVM Service 1, Refreshed Property Value AVM Service 2, Refreshed Property Value AVM Service 3, Confidence Score, Value Variance, AVM Service 1 Forecast 6 Mth (%), CI Score, CI Score Grade, Recon Recommendation, Consensus Quality, Consensus Value, Total Liens On Property, Total Liens On Property Previous, Lien Information Service 1st Lien, Lien Information Service 2nd Lien, Lien Information Service 3rd Lien, Credit Report Discrepancy, Filing/Recording Discrepancy, Lien Address Discrepancy, and Own Other Property.

The data elements listed on the Predictive Analytics data elements page may include ATP Index, ATP Risk Grade, Borrower Income 360, Co-Borrower Income 360, Predictive Analytics Service 1 Delinquency Current (%), Predictive Analytics Service 1 Delinquency Delinquent (%), Predictive Analytics Service 1 Delinquency Seriously Delinquent (%), Predictive Analytics Service 1 Delinquency Terminated (%), Predictive Analytics Service 2 Risk Grade, Predictive Analytics Service 2 Foreclosure Frequency AAA (%), Predictive Analytics Service 2 Foreclosure Frequency AA+(%), Predictive Analytics Service 2 Foreclosure Frequency AA (%), Predictive Analytics Service 2 Foreclosure Frequency AA−(%), Predictive Analytics Service 2 Foreclosure Frequency A+(%), Predictive Analytics Service 2 Foreclosure Frequency A (%), Predictive Analytics Service 2 Foreclosure Frequency A−(%), Predictive Analytics Service 2 Foreclosure Frequency BBB+(%), Predictive Analytics Service 2 Foreclosure Frequency BBB (%), Predictive Analytics Service 2 Foreclosure Frequency BBB−(%), Predictive Analytics Service 2 Foreclosure Frequency BB+(%), Predictive Analytics Service 2 Foreclosure Frequency BB (%), Predictive Analytics Service 2 Foreclosure Frequency BB−(%), Predictive Analytics Service 2 Foreclosure Frequency B+(%), Predictive Analytics Service 2 Foreclosure Frequency B (%), Predictive Analytics Service 2 Foreclosure Frequency B−(%), Predictive Analytics Service 2 Loss Severity AAA (%), Predictive Analytics Service 2 Loss Severity AA+(%) Predictive Analytics Service 2 Loss Severity AA (%), Predictive Analytics Service 2 Loss Severity AA−(%), Predictive Analytics Service 2 Loss Severity A+(%), Predictive Analytics Service 2 Loss Severity A (%), Predictive Analytics Service 2 Loss Severity A−(%), Predictive Analytics Service 2 Loss Severity BBB+(%), Predictive Analytics Service 2 Loss Severity BBB (%), Predictive Analytics Service 2 Loss Severity BBB−(%), Predictive Analytics Service 2 Loss Severity BB+(%), Predictive Analytics Service 2 Loss Severity BB (%), Predictive Analytics Service 2 Loss Severity BB−(%), Predictive Analytics Service 2 Loss Severity B+(%), Predictive Analytics Service 2 Loss Severity B (%), Predictive Analytics Service 2 Loss Severity B−(%), Predictive Analytics Service 2 Loss Coverage AAA (%), Predictive Analytics Service 2 Loss Coverage AA+(%), Predictive Analytics Service 2 Loss Coverage AA (%), Predictive Analytics Service 2 Loss Coverage AA−(%), Predictive Analytics Service 2 Loss Coverage A+(%), Predictive Analytics Service 2 Loss Coverage A (%), Predictive Analytics Service 2 Loss Coverage A−(%), Predictive Analytics Service 2 Loss Coverage BBB+(%), Predictive Analytics Service 2 Loss Coverage BBB (%), Predictive Analytics Service 2 Loss Coverage BBB−(%), Predictive Analytics Service 2 Loss Coverage BB+(%), Predictive Analytics Service 2 Loss Coverage BB (%), and Predictive Analytics Service 2 Loss Coverage BB−(%), Predictive Analytics Service 2 Loss Coverage B+(%), Predictive Analytics Service 2 Loss Coverage B (%), Predictive Analytics Service 2 Loss Coverage B−(%), Predictive Analytics Service 2 Risk Ratio AAA (%), Predictive Analytics Service 2 Risk Ratio AA+(%), Predictive Analytics Service 2 Risk Ratio AA (%), Predictive Analytics Service 2 Risk Ratio AA−(%), Predictive Analytics Service 2 Risk Ratio A+(%), Predictive Analytics Service 2 Risk Ratio A (%), Predictive Analytics Service 2 Risk Ratio A−(%), Predictive Analytics Service 2 Risk Ratio BBB+(%), Predictive Analytics Service 2 Risk Ratio BBB (%), Predictive Analytics Service 2 Risk Ratio BBB−(%), Predictive Analytics Service 2 Risk Ratio BB+(%), Predictive Analytics Service 2 Risk Ratio BB (%), Predictive Analytics Service 2 Risk Ratio BB−(%), Predictive Analytics Service 2 Risk Ratio B+(%), Predictive Analytics Service 2 Risk Ratio B (%), Predictive Analytics Service 2 Risk Ratio B−(%), Predictive Analytics Service 1 Cumulative Default (%), Predictive Analytics Service 1 Prepayment (%), Predictive Analytics Service 1 Prepayment Amount, Predictive Analytics Service 1 Loss Severity (%), Predictive Analytics Service 1 Loss Severity Amount, and Predictive Analytics Service 1 Cumulative Loss (%).

The reporting and alerting engine 850 may also display a Refresh Status report in response to an instruction from a user. The Refresh Status report may include a Last 30 days section that displays a vendor activity list of all vendor activity during the last 30 days.

The Refresh Status report may also include a Historical section that may display a From date text box with a pop-up calendar, a To date text box with a pop-up calendar, and a Run Report button. The user can enter a From date and a To date, and then press the Run Report button to display a vendor activity list of all vendor activity during the period between the two dates.

The listing for each vendor activity in the vendor activity list in both sections may include the vendor, the service that was run, the name of the loan pool for which the service was run, the total number of loans for which the service was run, the start date, the complete date, the turn time in hours, the number of hits, and the hit rate, which is the number of hits divided by the number of loans times 100.

The Activity report may also include a Experts & Resources section that may list the vendors that provided vendor loan data during the runs.

Although several embodiments have been shown and described, it will be appreciated by one of ordinary skill in the art that changes may be made in these embodiments without departing from the principles and spirit of the invention, the scope of which is defined in the claims and their equivalents.

What is claimed is:

1. A loan management, real-time monitoring, analytics, and data refresh system comprising:
a loan data importing and validating engine configured to import user loan data, validate the imported loan data, and load the validated loan data into a loan queue under control of the user;
a loan/pool managing and analyzing engine configured to select loans in the loan queue, place the selected loans into a loan pool, and analyze selected loans in the loan pool under control of the user;
a vendor data integrating engine and auto-scheduler configured to automatically operate without control of the user to extract loan data from the loan data for the loans in the loan pool, submit the extracted loan data to a loan-data vendor, receive vendor loan data generated by the loan data vendor from the extracted loan data, and integrate the vendor loan data with the loan data for the loans in the loan pool; and
a reporting and alerting engine configured to generate reports and alerts from the integrated loan data for the loans in the loan pool under control of the user.

2. The system of claim 1, wherein the loan data importing and validating engine is further configured to automatically correct errors in address data in the user loan data as part of the data validating.

3. The system of claim 1, wherein the loan data importing and validating engine is further configured to determine whether any data elements are missing or invalid in the user loan data;
determine, for any data element that is missing or invalid, whether the missing or invalid data element is a fatal error that will prevent the vendor loan data from being obtained from the loan-data vendor, or a warning indicating that the data element is necessary to obtain the vendor loan data from the loan-data vendor but is not a fatal error; or missing address information, or an analytic error indicating that the data element is necessary to display certain charts, graphs, data tables, data analyses, trends, or other analytics in one or more reports; and
generate a data quality report identifying any fatal error, any warning, any missing address information, and any analytic error.

4. The system of claim 1, wherein the loan data importing and validating engine is further configured to import the user loan data in any format desired by the user, and load the validated loan data into the loan queue in a system format required by the system.

5. The system of claim 4, wherein the loan data importing and validated engine is further configured to convert the user loan data in the user format to the system format using a data mapping template selected or created under control of the user.

6. The system of claim 5, wherein the loan data importing and validating engine is further configured to:
create the data mapping template by displaying a list of data elements in the user loan data in the loan queue with a drop-down box by each data element listing data elements of the system format to enable the user to map the data elements in the user loan data to the data elements of the system format by selecting a data element of the system format for each of the data elements in the user loan data using the drop-down boxes; and
save the mappings as the data mapping template.

7. The system of claim 1, wherein the loan/pool managing and analyzing engine is further configured to selectively display pre-defined pool-level reports for one or more selected loan pools and pre-defined loan-level reports for loans in one or more selected loan pools under control of the user.

8. The system of claim 7, wherein the pre-defined pool-level reports comprise reports comprising:
selected user loan data;
selected vendor loan data;
at least one graphical indicator displaying the selected vendor loan data;
at least one graphical indicator indicating a trend in the selected vendor loan data;
at least one historical graph showing the trend in the selected vendor loan data; and
an alert section displaying any alert that may have been triggered for any of the selected user loan data and the selected vendor loan data.

9. The system of claim 1, wherein the reports comprise a Risk Card comprising:
a plurality of loan data elements; and
a risk gauge for each loan data element, the risk gauge comprising:
a low risk section representing a low risk range of the loan data element;
a moderate risk section representing a moderate risk range of the loan data element; and
a high risk section representing a high risk range of the loan data element;
wherein the low risk section for the loan data element is highlighted in a first color if a value of the loan data element is in the low risk range;
the moderate risk section for the loan data element is highlighted in a second color different from the first color if the value of the loan data element is in the moderate risk range; and
the high risk section for the loan data element is highlighted in a third color different from the first color and the second color if the value of the loan data element is in the high risk range.

10. The system of claim 1, wherein the vendor data integrating engine and auto-scheduler is further configured to submit the extracted loan data to a plurality of loan-data vendors according to a predetermined stacking order that depends on the loan data required by each of the loan-data vendors.

11. The system of claim 1, wherein the reporting and alerting engine is further configured to create a search to search the loans in the loan pool using one or more data elements of the integrated loan data under control of the user; and
display results of the search.

12. The system of claim 11, wherein the reporting and alerting engine is further configured to:
display the results of the search by displaying a loan pool summary of results of the search;
refine the search by adding one or more data elements to the search, or deleting one or more data elements from the search, or changing search values one or more data elements of the search, or any combination thereof, under control of the user; and
recalculate and display the loan pool summary each time the search is refined.

13. The system of claim 1, wherein the reporting and alerting engine is further configured to provide at least one pre-defined alert to automatically alert the user of a change in a data element of the vendor loan data when activated by the user.

14. The system of claim 13, wherein the reporting and alerting engine is further configured to e-mail to one or more recipients designated by the user a notification that the pre-defined alert has been triggered by the change in the data element of the vendor loan data.

15. The system of claim 1, wherein the reporting and alerting engine is further configured to enable the user to create at least one custom alert to automatically alert the user of a change in any data element of the vendor loan data when activated by the user.

16. The system of claim 15, wherein the reporting and alerting engine is further configured to e-mail to one or more recipients designated by the user a notification that the custom alert has been triggered by the change in the data element of the vendor loan data.

17. The system of claim 1, wherein the reporting and alerting engine is further configured to selectively display pre-defined and/or custom on-demand pool-level reports for one or more selected loan pools and pre-defined loan-level reports for loans in one or more selected loan pools under control of the user.

18. The system of claim 17, wherein the pre-defined and/or custom on-demand pool-level reports comprise reports comprising:
selected user loan data;
selected vendor loan data;
at least one graphical indicator displaying the selected vendor loan data;
at least one graphical indicator indicating a trend in the selected vendor loan data; and
at least one historical graph showing the trend in the selected vendor loan data.

19. A loan management, real-time monitoring, analytics, and data refresh method comprising:
importing user loan data, validating the imported loan data, and loading the validated loan data into a loan queue under control of the user;
selecting loans in the loan queue and placing the selected loans into a loan pool under control of the user;
automatically without control of the user extracting loan data from the loan data for the loans in the loan pool, submitting the extracted loan data to a loan-data vendor, receiving vendor loan data generated by the loan data vendor from the extracted loan data, and integrating the vendor loan data with the loan data for the loans in the loan pool; and
generating reports and alerts from the integrated loan data for the loans in the loan pool under control of the user.

20. The method of claim 19, wherein the reports comprise a Risk Card comprising:
a plurality of loan data elements; and
a risk gauge for each loan data element, the risk gauge comprising:
a low risk section representing a low risk range of the loan data element;
a moderate risk section representing a moderate risk range of the loan data element; and
a high risk section representing a high risk range of the loan data element;
wherein the low risk section for the loan data element is highlighted in a first color if a value of the loan data element is in the low risk range;
the moderate risk section for the loan data element is highlighted in a second color different from the first color if the value of the loan data element is in the moderate risk range; and
the high risk section for the loan data element is highlighted in a third color different from the first color and the second color if the value of the loan data element is in the high risk range.

21. The method of claim 19, further comprising:
creating a search to search the loans in the loan pool using any one or more data element of the integrated loan data under control of the user;
displaying a loan pool summary of results of the search;
refining the search by adding one or more data elements to the search, or deleting one or more data elements from the search, or changing search values one or more data elements of the search, or any combination thereof, under control of the user; and
recalculating and redisplaying the loan pool summary each time the search is refined.
